(19) United States
(12) Patent Application Publication
(10) Pub. No.: US 2012/0249995 A1
(43) Pub. Date: Oct. 4, 2012

(54) RESIST PROTECTIVE FILM MATERIAL AND PATTERN FORMATION METHOD

(75) Inventors: Jun Hatakeyama, Joetsu-shi (JP); Yuji Harada, Joetsu-shi (JP); Takeru Watanabe, Joetsu-shi (JP)

(73) Assignee: SHIN-ETSU CHEMICAL CO. LTD., Tokyo (JP)

(21) Appl. No.: 13/494,746

(22) Filed: Jun. 12, 2012

Related U.S. Application Data
(62) Division of application No. 11/550,204, filed on Oct. 17, 2006.

(30) Foreign Application Priority Data
Oct. 17, 2005 (JP) 2005-301197
Mar. 10, 2006 (JP) 2006-065836

(51) Int. Cl. G03B 27/32

(52) U.S. Cl. 355/77

(57) ABSTRACT

The invention is a protective film material for immersion lithography that enables desirable immersion lithography, can be removed simultaneously with development of a photoresist layer, and has excellent process adaptability. The invention also includes a method for forming a pattern using the material. More specifically, the invention is a protective film material comprising (i) a blend of a polymer comprising a repeating unit having a fluorine-containing alkyl or alkylene group which contains at least one fluorine atom and an optional alkali soluble repeating unit and a polymer comprising a repeating unit having a fluorine-free alkyl group and an optional alkali soluble repeating unit, or (ii) a polymer comprising a repeating unit having a fluorine-containing alkyl or alkylene group which contains at least one fluorine atom and a repeating unit having a fluorine-free alkyl group and an optional alkali-soluble repeating unit.

### CROSS-REFERENCE TO RELATED APPLICATIONS

This application is a divisional of U.S. application Ser. No. 11/550,204, filed Oct. 17, 2006, which claims priority to Japanese Application No. 2005-301197, filed Oct. 17, 2005 and Japanese Application No. 2006-065836, filed Mar. 10, 2006, each of which is incorporated herein by reference in their entirety.

### BACKGROUND OF THE INVENTION

1. Field of the Invention

The present invention relates to a resist protective film material to be used as a layer on or above a photoresist layer for protecting the photoresist layer in fine processing in the fabrication of a semiconductor device, particularly in immersion lithography of introducing water between a projector lens and a wafer and using an ArF excimer laser having a wavelength of 193 nm as a light source; and a method for forming a resist pattern using the material.

2. Description of the Related Art

In the recent drive for higher integration and higher operation speed in LSI devices, a demand for a finer pattern rule is high. However, light exposure which is currently on widespread use in the art is approaching the essential limit of resolution determined by the wavelength of a light source. As the exposure light for the formation of a resist pattern, g-line (436 nm) or i-line (365 nm) from a mercury lamp was widely employed. A method of reducing the wavelength of exposure light was regarded effective as means for reducing the feature size further. For the mass production process on and after 64 M-bit dynamic random access memory (DRAM, processing feature size 0.25 μm or less), a KrF excimer laser having a shorter wavelength (248 nm) was utilized instead of i-line (365 nm) as the exposure light source. For the fabrication of DRAM having an integration degree of 256 M and 1 G or greater requiring a finer patterning technology (processing feature size: 0.2 μm or less), a shorter wavelength light source is required. Over a decade, photolithography using ArF excimer laser (193 nm) has been investigated intensively. At first, although ArF lithography had been planned to be applied to the fabrication of 180-nm node devices, the KrF excimer lithography survived to the mass production of 130-nm node devices. Then, the full application of ArF lithography started from the 90-nm node. Application of the ArF lithography to 65 nm node devices combined with a lens having an increased NA of 0.9 is under investigation. For the next 45-nm node devices, F₂ lithography of 157 nm wavelength became a candidate as a result of promotion of a reduction in the wavelength of an exposure light. Because of various problems such as an increase in the cost of a scanner owing to use of a large amount of expensive CaF₂ single crystal for a projector lens, inevitable change of the optical system caused by the introduction of hard pellicles to overcome extremely low durability of soft pellicles, and lowering of etch resistance of a resist, postponed introduction of F₂ lithography and early introduction of ArF immersion lithography were advocated (see Proc. SPIE Vol. 4690 xxix).

In the ArF immersion lithography, filling of the space between a projection lens and a wafer with water is proposed. Since water has a refractive index of 1.44 at 193 nm, pattern formation can be carried out even by using a lens with NA of 1.0 or greater. Theoretically, the NA can be increased to 1.44. The resolution is improved by an increment of NA. Combination of a lens having NA of at least 1.2 with ultra-high resolution technology suggests the possibility of the 45 nm node device (see Proc. SPIE Vol. 5040, p 724).

Several problems caused by water present on a resist film have been pointed out. For example, an acid generated or an amine compound added to the resist film as a quencher is dissolved in water and causes a change in profile, or a pattern collapses due to swelling. Providing a protective film between the resist film and water is therefore proposed as an effective means (see the 2nd Immersion Workshop, Jul. 11, 2003, Resist and Cover Material Investigation for Immersion Lithography).

The protective film on the resist layer has so far been studied as an antireflective film. For example, the ARCOR process is disclosed in Japanese Patent Application Unexamined Publication Nos. 62-62520/1987, 62-62521/1987 and 60-38821/1985. The ARCOR process involves forming a transparent antireflective film on a resist film and removing it after exposure. It is a convenient process in which fine patterns can be formed with a high degree of accuracy and alignment accuracy. When a perfluoroalkyl compound (for example, perfluoroalkyl polyether or perfluoroalkyl amine) having a low refractive index is used as a material for an antireflective film, reflected light on the interface between the resist and antireflective film decreases greatly so that the dimensional precision is enhanced. In addition to the above-described material, the fluorine-containing material is proposed to include amorphous polymers such as perfluoro(2,2-dimethyl-1,3-dioxol)-tetrafluoroethylene copolymers and cyclic polymers of perfluoro(allyl vinyl ether) and perfluorobutenyl vinyl ether which are reported in Japanese Patent Application Unexamined Publication No. 5-74700/1993.

Because of low compatibility with organic substances, the perfluoroalkyl compounds are diluted with fluorocarbon or the like for controlling a coating thickness. As is well-known in the art, use of fluorocarbon now becomes a problem from the standpoint of environmental protection. In addition, the above compounds do not have a uniform film forming property so that they are not suited for the preparation of antireflective films. Moreover, the antireflective films prepared using such compounds have to be removed using fluorocarbon prior to the development of a photoresist film. Accordingly, there are many practical disadvantages including a need to add a unit for removing an antireflective film to the existing system and an increase in the cost of fluorocarbon solvents.

If the antireflective film is removed without adding an extra unit to the existing system, use of a development unit for removing is most preferred. In the development unit of a photoresist, an aqueous alkaline solution is used as a developer and pure water is used as a rinsing solution. An antireflective film material which can easily be removed by these solutions is desirable. A number of water soluble antireflective film materials and pattern forming methods using them are proposed for this purpose, for example, in Japanese Patent Application Unexamined Publication No. 6-273926/1994 and Japanese Patent Publication No. 2803549.

However, the water-soluble protective films are dissolved in water during exposure so that they cannot be used in the immersion lithography. On the other hand, water-insoluble fluorine-containing polymers need a special fluorocarbon removing agent and a removing cup exclusively used for fluorocarbon solvents. There is accordingly a demand for the development of a resist protective film which is insoluble in water and can be removed readily.

A top coat mainly comprises methacrylate with pendant hexafluoroalcohol and soluble in a developer is proposed (J. Photopolymer Sci. and Technol., 18(5), 615(2005)). This top coat has Tg as high as 150° C., has high alkali solubility and good suitability with a resist.

In order to increase the scan speed of exposure equipment, a water-sliding property of a photoresist protective film to be contacted with water has to be improved. It is reported that combination of different water-repellent groups and formation of a microdomain structure as well as improvement of water repellency is effective for improving the water-sliding property. For example, a fluorine resin having siloxane grafted exhibits very excellent water-sliding property (see XXIV FATIPEC Congress Book, Vol. B, p 15-38(1997)). This resin is superior in water-sliding property to a fluorine resin only or a silicone resin only and is found to have a domain structure of from 10 to 20 nm as a result of TEM observation (see Progress in Organic Coatings, 31, p 97-104(1997).

### SUMMARY OF THE INVENTION

With the foregoing in view, the present invention has been made. An object of the present invention is to provide a protective film material for immersion lithography which material enables desirable immersion lithography and has excellent process adaptability because the material can be removed simultaneously with the development of a photoresist layer; and a method for forming a pattern using such a material.

The present inventors carried out an extensive investigation with a view of attaining the above object. As a result, it was found that a microphase-separated structure is formed by combining a repeating unit having a perfluoroalkyl group as a hydrophobic group with a repeating unit having an alkyl group, and a material having such a structure is promising as a resist protective film material having a very low water-sliding angle. Then, the present invention was completed.

The present invention can provide a resist protective film material comprising (i) a blend of a polymer comprising a repeating unit having a fluorine-containing alkyl or alkylene group which contains at least one fluorine atom and an optional alkaline solution-soluble repeating unit and a polymer comprising a repeating unit having a fluorine-free alkyl group and an optional alkaline solution-soluble repeating unit, or (ii) a polymer comprising a repeating unit having a fluorine-containing alkyl or alkylene group which contains at least one fluorine atom, a repeating unit having a fluorine-free alkyl group and an optional alkali soluble repeating unit. The present invention can preferably provide a resist protective film having a microphase-separated structure with a domain size not greater than 50 nm, which the film is obtained by using the resist protective film material. Further, the present invention can provide a method for forming a pattern, comprising a protective film formation step of using the protective film material on or above a photoresist layer formed on or above a wafer, an exposure step and a development step.

The resist protective film material and protective film according to the present invention can be used not only in the pattern forming method using ordinary lithography but also immersion lithography in which exposure is performed in a liquid. In the pattern forming method using immersion lithography, a resist protective film formed on or above a resist film is insoluble in water but soluble in an aqueous alkaline solution (alkali developer) and at the same time it does not mix with the resist film so that desirable immersion lithography can be carried out. In addition, removal of the protective film and development of the resist film can be carried out simultaneously during alkali development.

### DETAILED DESCRIPTION OF THE PREFERRED EMBODIMENT(S)

The present invention relates to a pattern forming method using lithography (preferably immersion lithography) comprising steps of forming a resist protective film of a resist overlay film material on or above a photoresist layer formed on or above a wafer, exposing (preferably exposing in water) and then developing.

The resist overlay film material may preferably comprise a polymer or polymers comprising a repeating unit having, as a hydrophobic group, a fluorine-containing alkyl group which contains at least one fluorine atom and/or a repeating unit having a fluorine-free alkyl group and an optional alkaline solution-soluble repeating unit. For example, a blend of a polymer comprising a repeating unit having a fluorine-containing alkyl group and an optional alkaline solution-soluble repeating unit and a polymer comprising a repeating unit having a fluorine-free alkyl group and an optional alkaline solution-soluble repeating unit may be used. A polymer comprising a repeating unit having a fluorine-containing alkyl group and a repeating unit having a fluorine-free alkyl group and an optional alkaline-solution soluble repeating unit may be used.

A repeating unit having a perfluoroalkyl group can preferably be selected from the group consisting of repeating units A1, A2 and A3 in the following formula (1). A repeating unit of a fluorine-containing alkylene group which contains at least one fluorine atom can preferably be selected from the repeating unit A4 in the following formula (1).

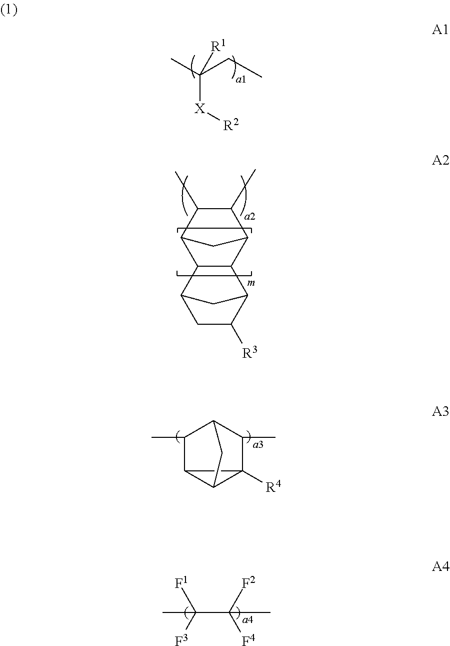

In the above formulas, R¹ represents a hydrogen atom, a fluorine atom, a methyl group or a trifluoromethyl group; R², R³ and R⁴ each independently represents a C₁₋₂₀ alkyl group having at least one fluorine atom and may have an ether or ester group; X represents —O— or —C(═O)—O—; m represents 0 or 1; and F¹ to F⁴ each independently represents an atom or group selected from the group consisting of a fluorine atom, a hydrogen atom, a methyl group and a trifluoromethyl group, with the proviso that F¹ to F⁴ contain at least one fluorine atom.

The fluorine-containing alkyl group which contains at least one fluorine atom may be preferably a perfluoroalkyl group or a substituted perfluoroalkyl group having a difluoromethyl group instead of the trifluoromethyl group.

Specific examples of the repeating units A1, A2 and A3 can be described below.

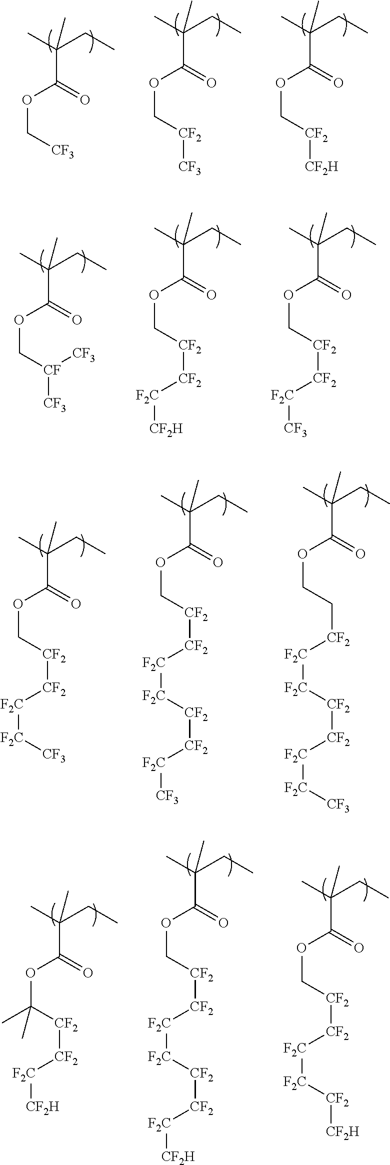

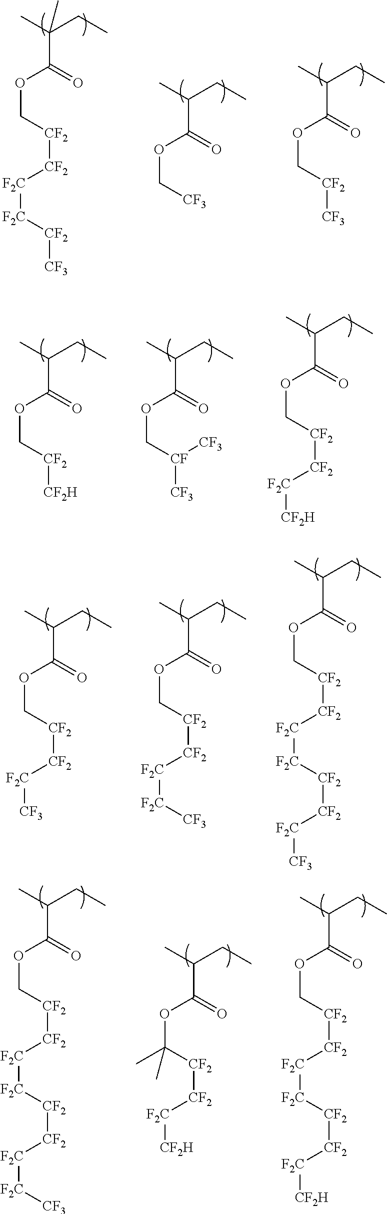

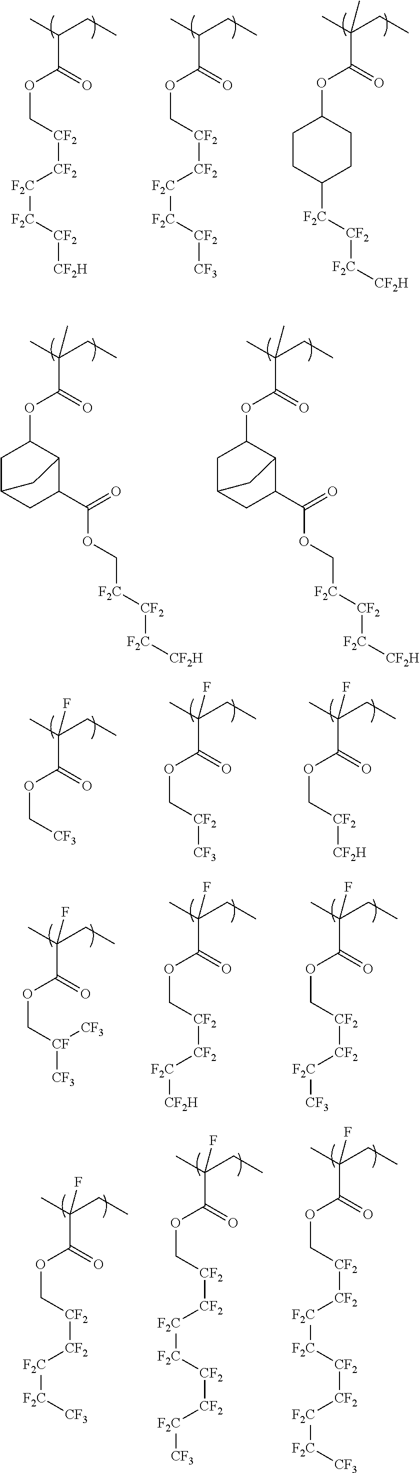

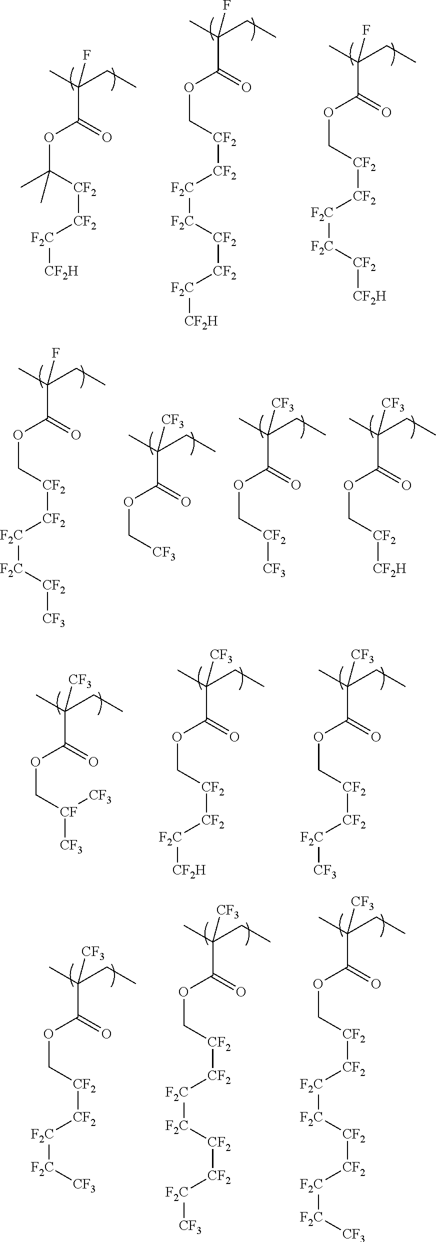

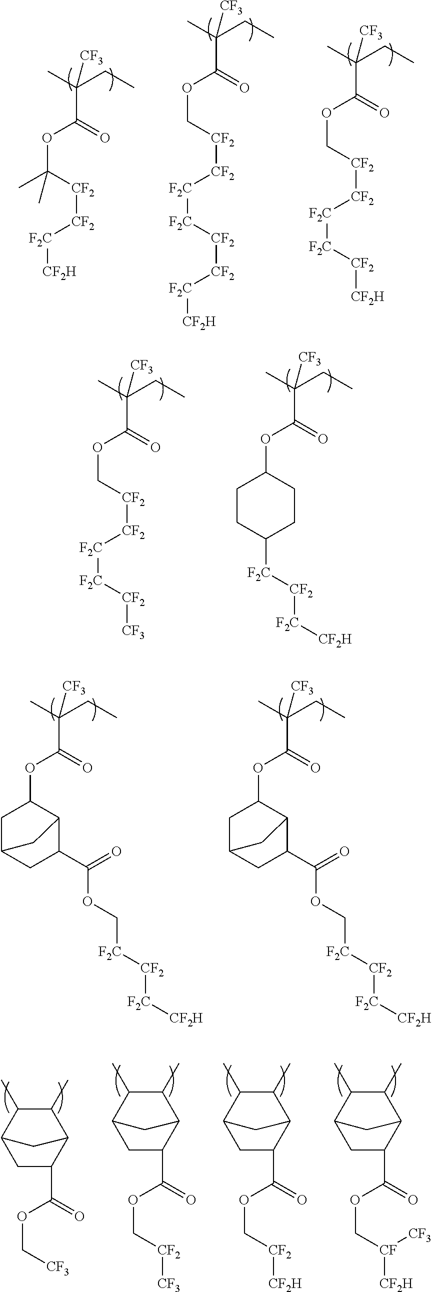

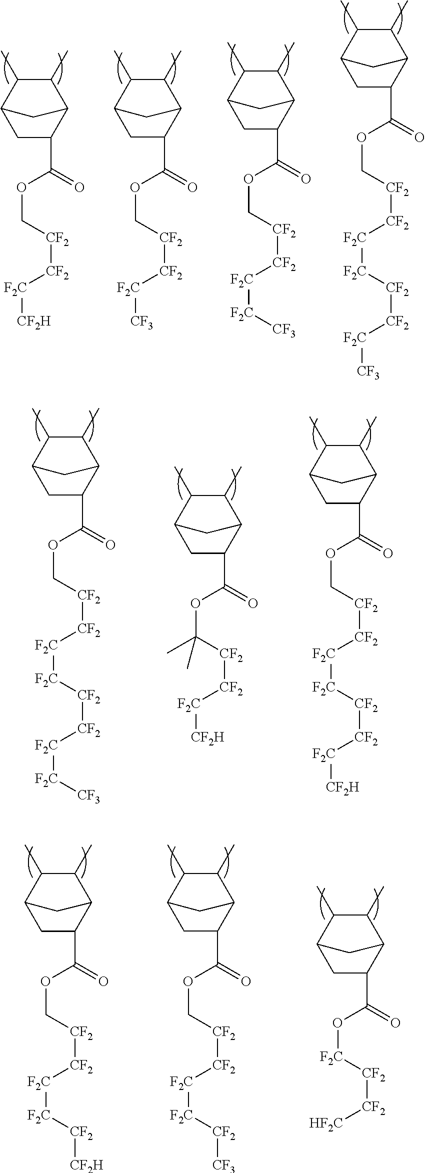

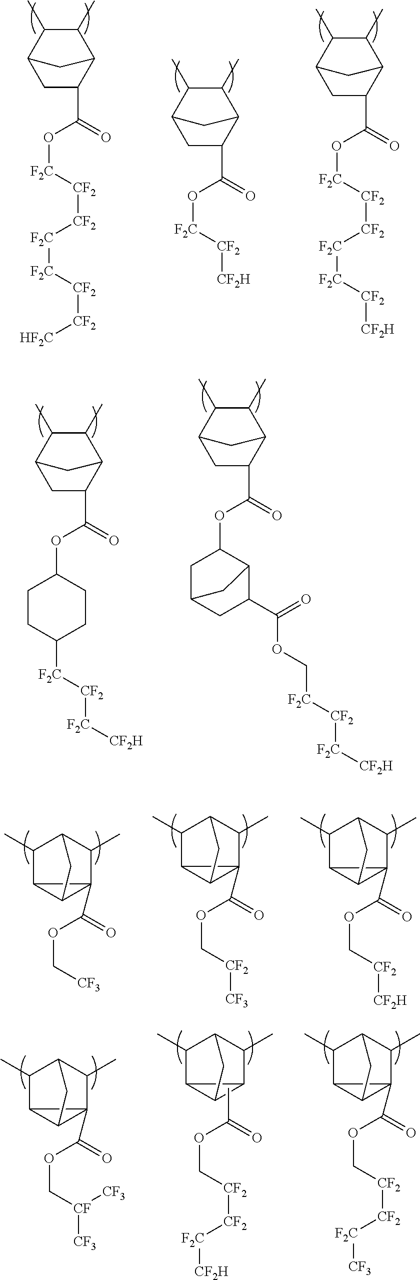

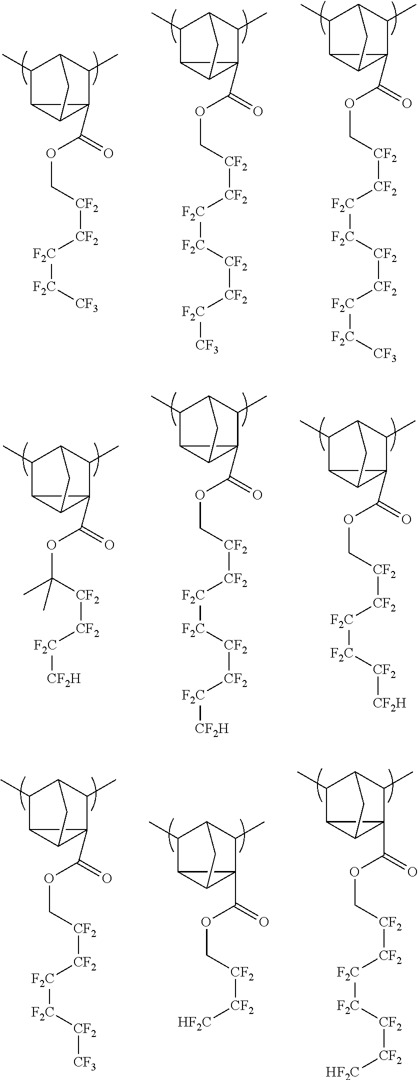

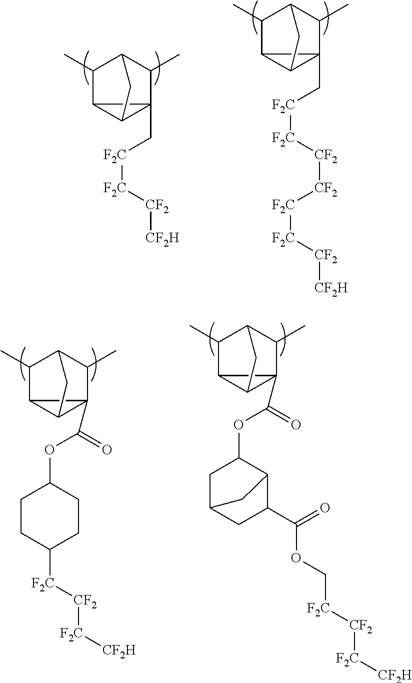

Specific examples of the repeating unit A4 having a fluorine-containing alkylene group which contains at least one fluorine atom can be described below.

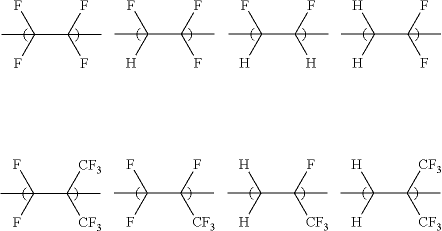

The repeating unit having a fluorine-free alkyl group can be selected from the group consisting of repeating units B1, B2 and B3 in formula (2) below.

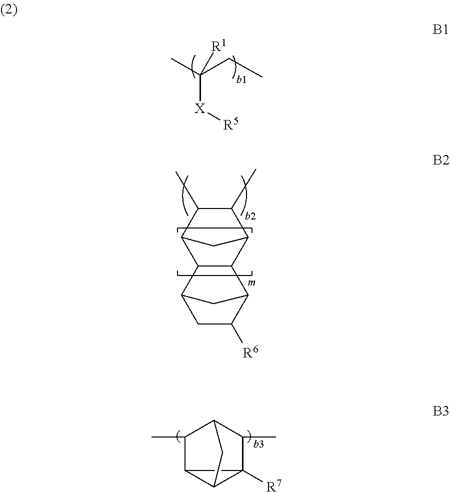

In the above formula, R¹, X and m have the same representations as described above, but they are designated independently from the formula (1) and may be the same or different from those of the formula (1). R⁵ and R⁶ each independently represents a fluorine-free C₁₋₂₀ alkyl group and may have an ether or ester group, and R⁷ represents a hydrogen atom or a fluorine-free C₁₋₂₀ alkyl group and may have an ether or ester group.

Specific examples of the repeating units B1, B2 and B3 can be described below.

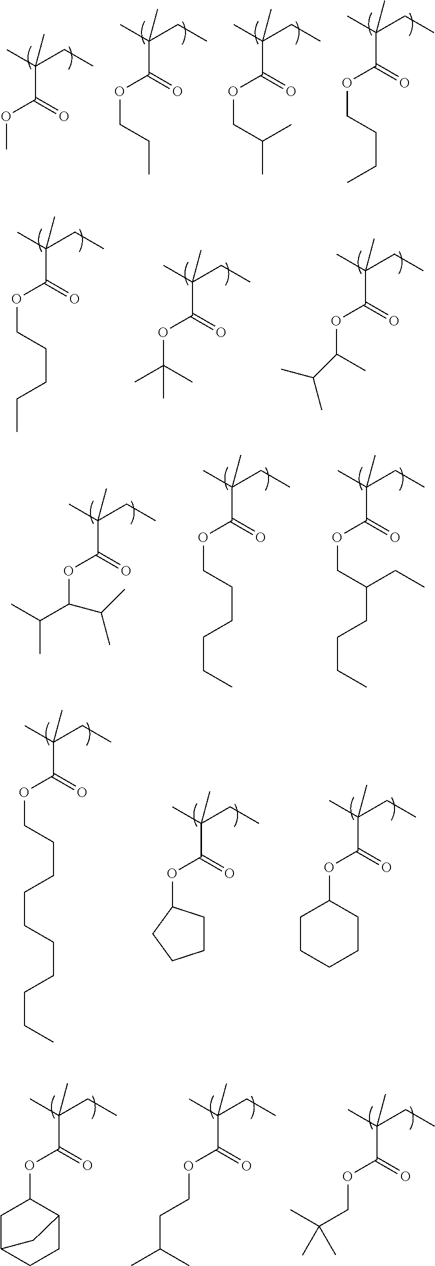

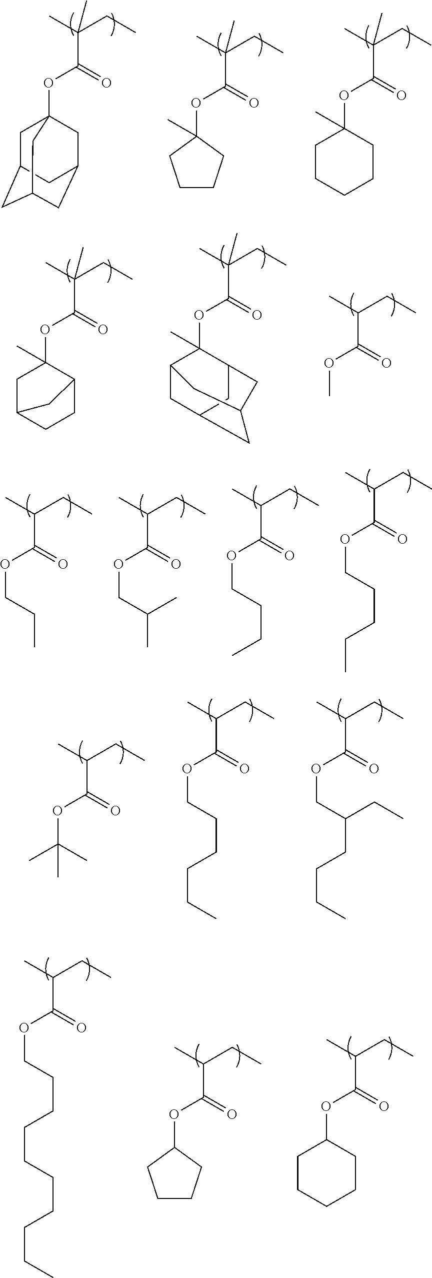

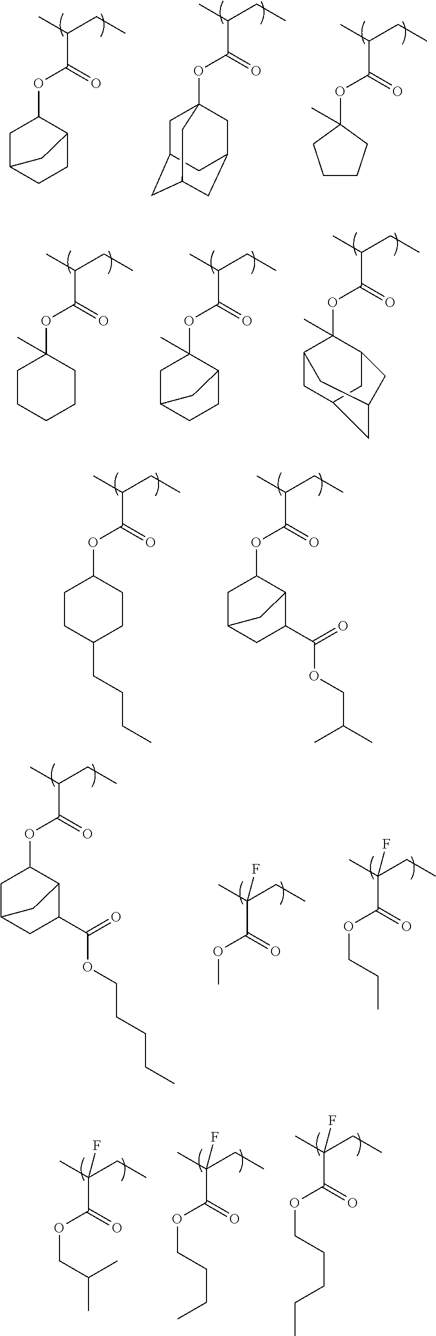

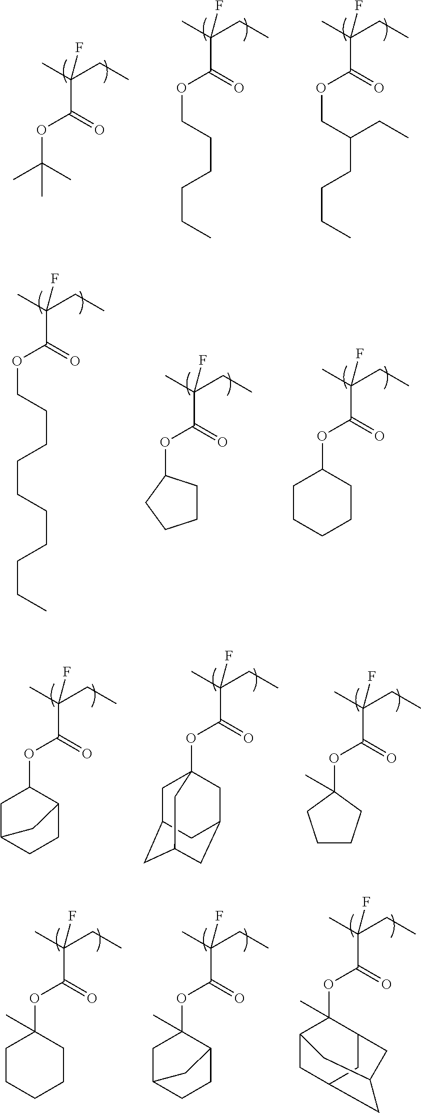

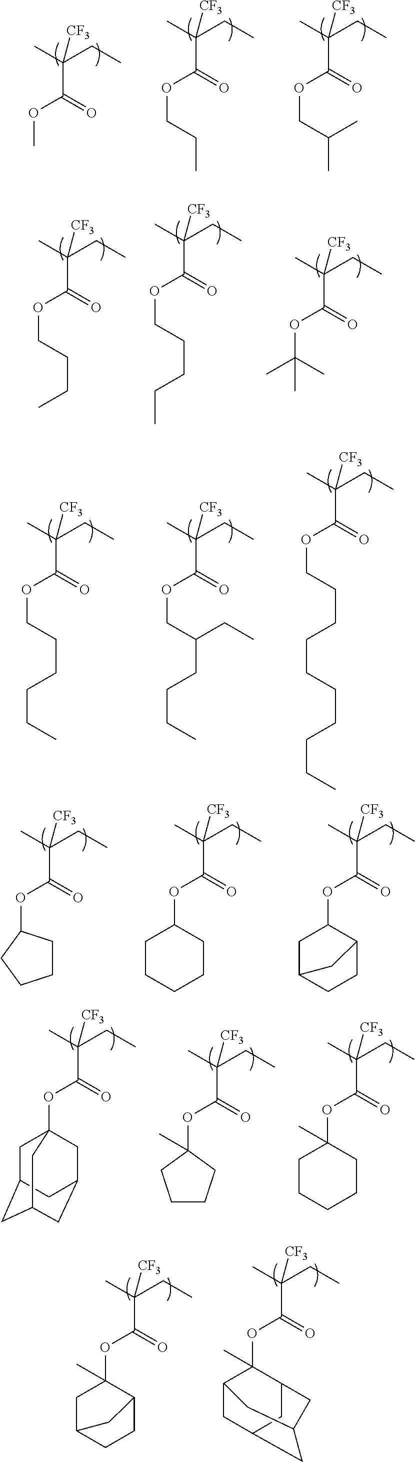

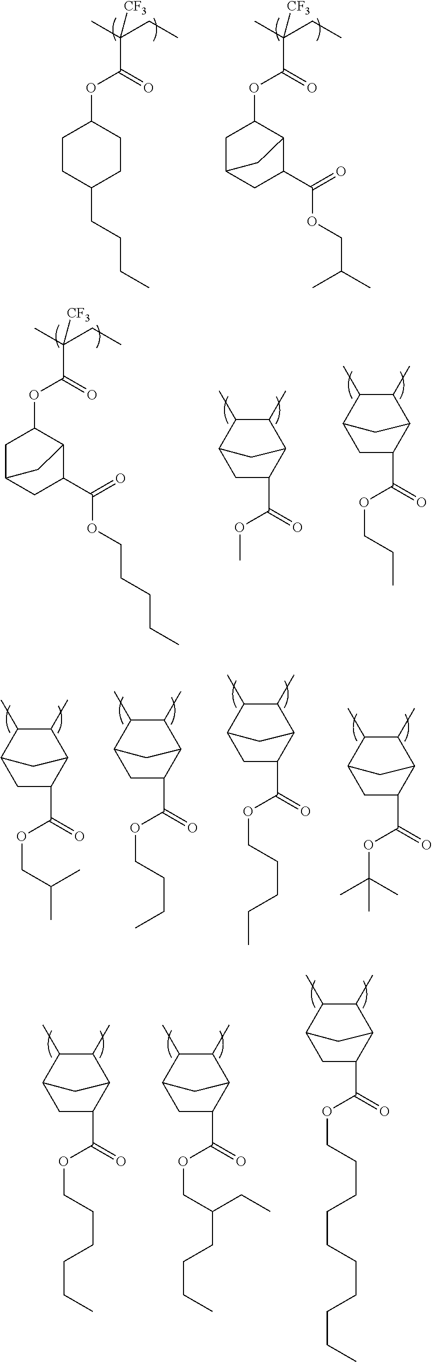

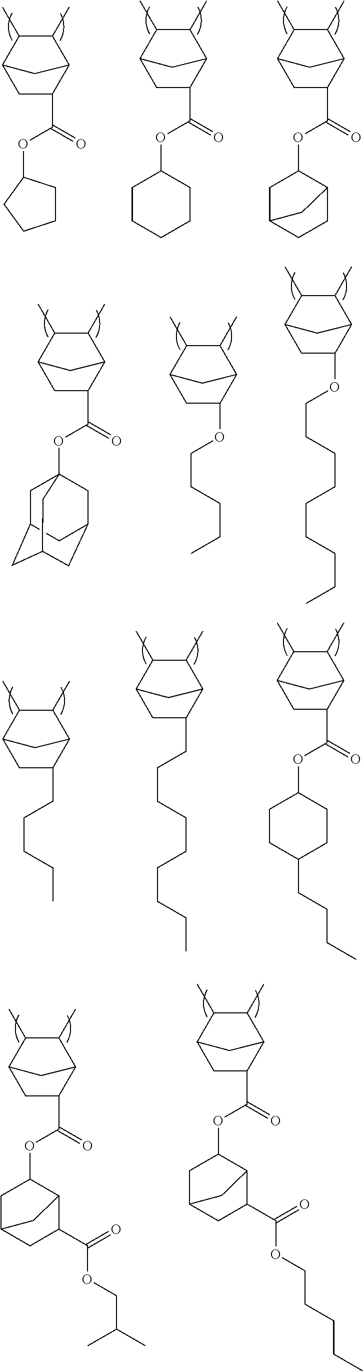

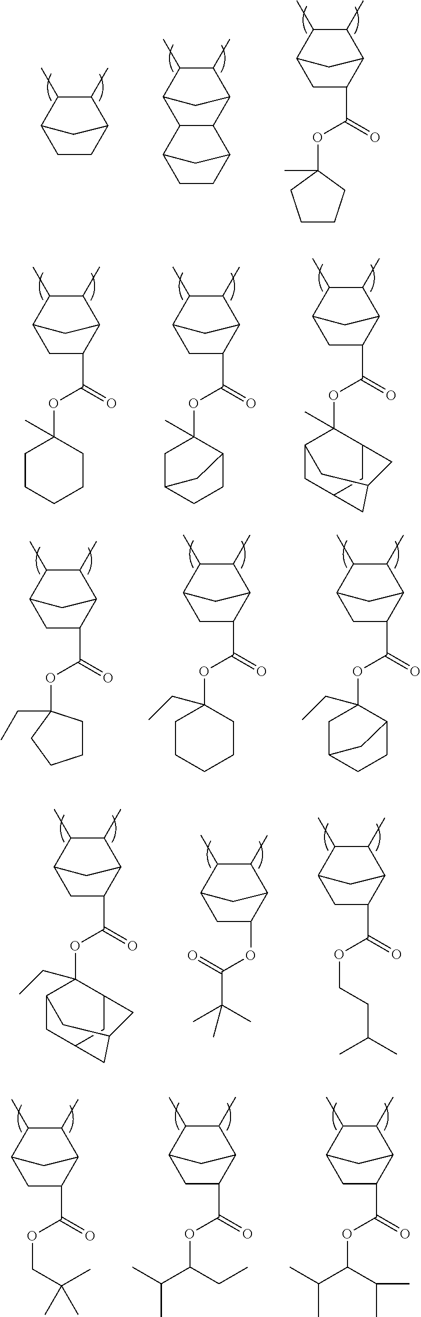

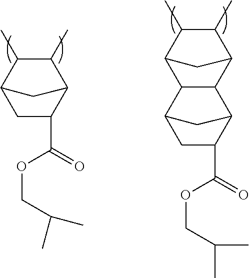

Proposed by the present invention is a resist protective film for immersion exposure featuring a high water-sliding property which can be obtained by combining a repeating unit having a fluorine-containing alkyl group (preferably a perfluoroalkyl group) or a fluorine-containing alkylene group (preferably a fluoroalkylene group) with a repeating unit having a fluorine-free alkyl group, thereby forming a microphase-separated structure. This resist protective film can be removed after exposure and post exposure bake (PEB). It may be removed using an organic solvent. Alternately, it may be removed during development by taking advantage of alkaline solution solubility. The alkaline solution solubility can be given by the presence of a repeating unit selected from A1 to A4, a repeating unit selected from B1 to B3 and an optional alkali solution-soluble repeating unit C.

The optional soluble group for attaining alkaline solution solubility which can be present with a repeating unit selected from A1 to A4 and a repeating unit selected from B1 to B3 will be explained.

Examples of the alkaline solution-soluble group may include a phenol group, a sulfo group, a carboxyl group and an α-trifluoromethyl alcohol. Of these, a carboxyl group and an α-trifluoromethyl alcohol may be preferred. Specific examples of the repeating unit having a carboxyl group or an α-trifluoromethyl alcohol can be shown below.

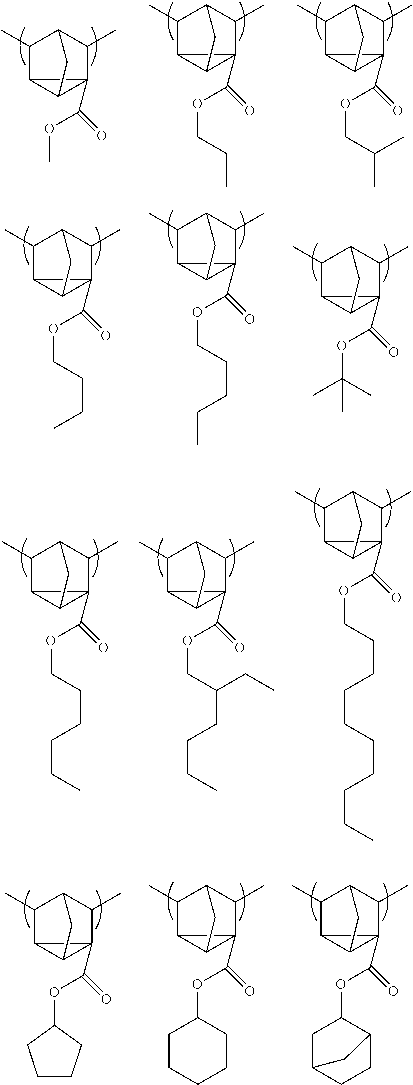

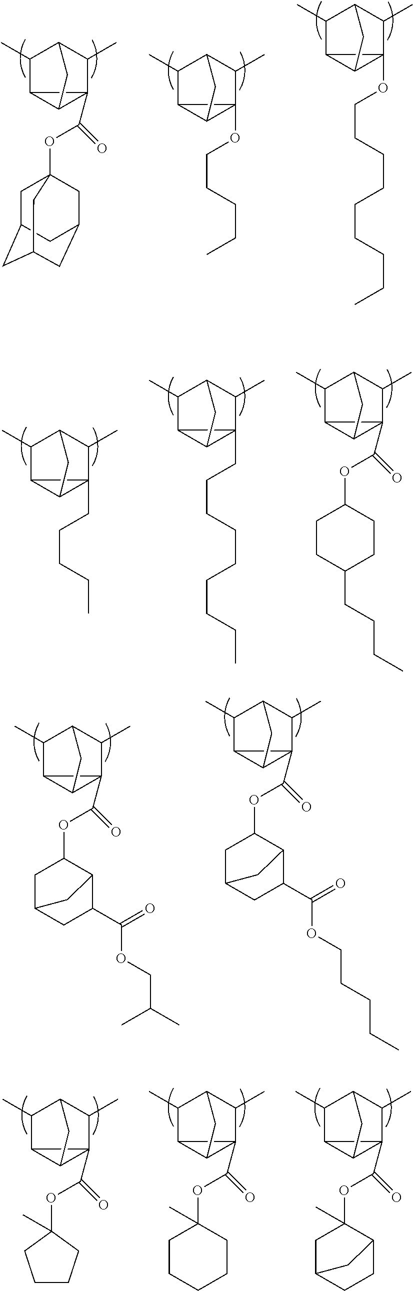

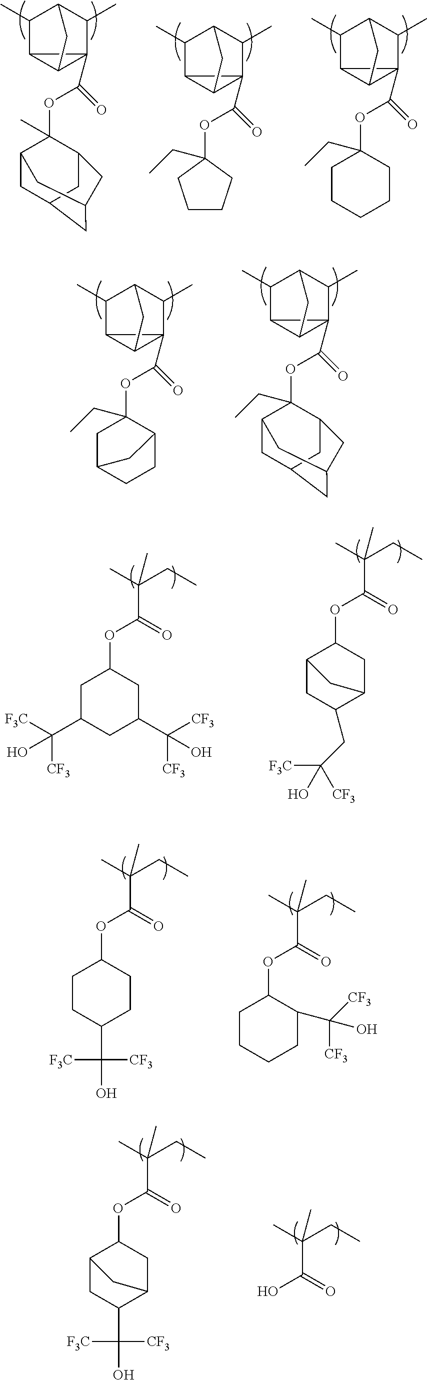

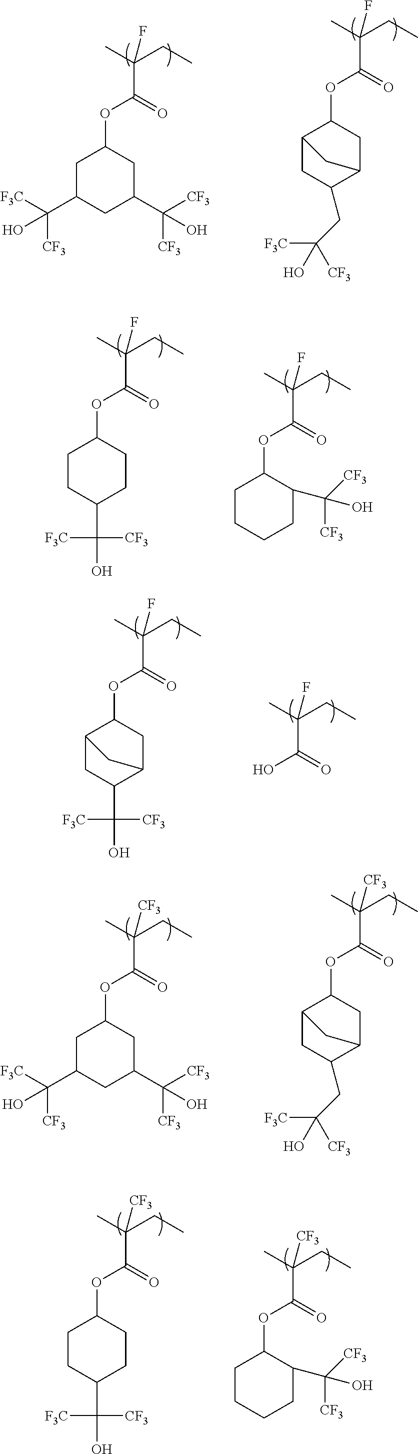

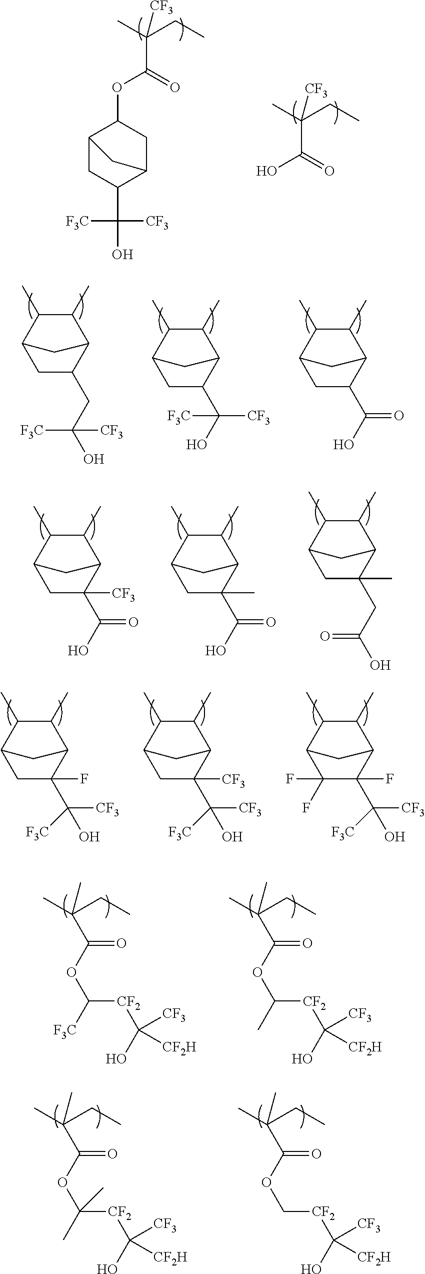

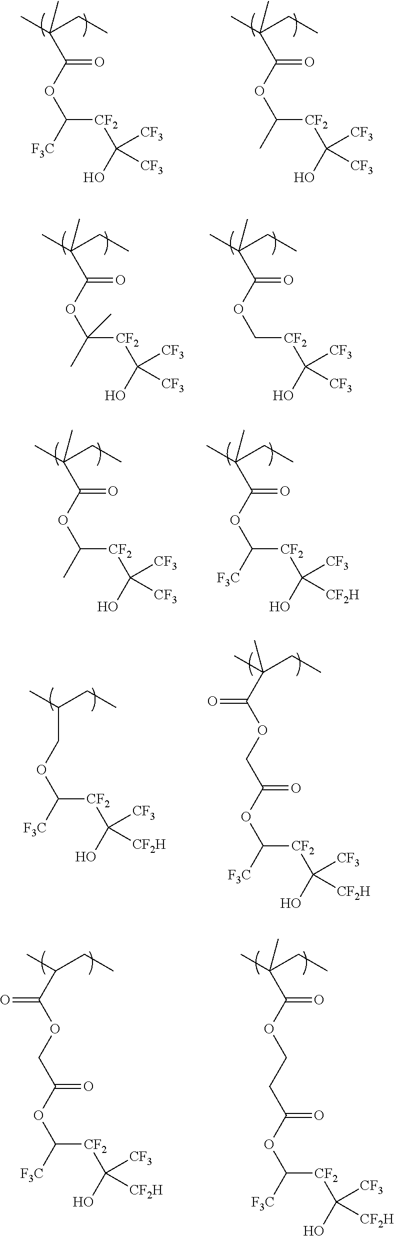

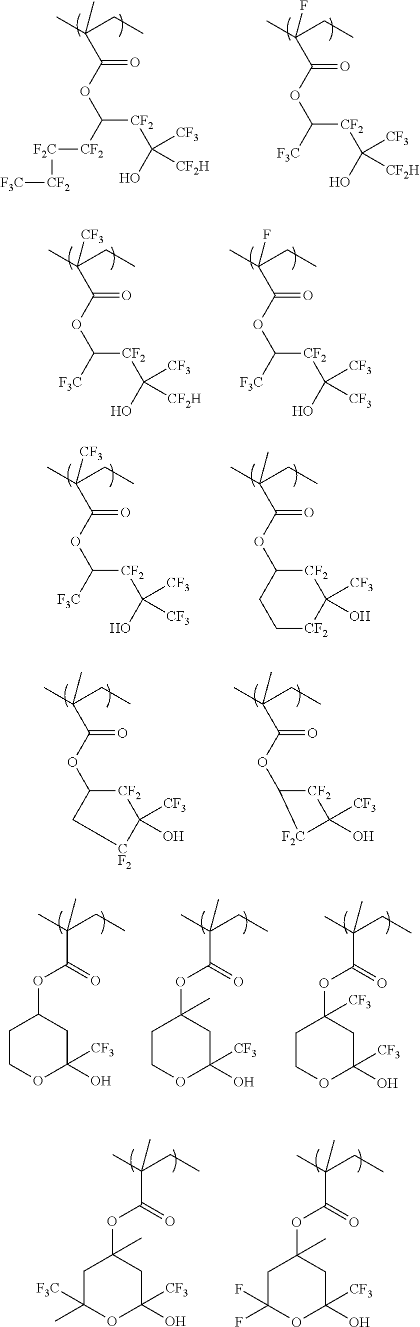

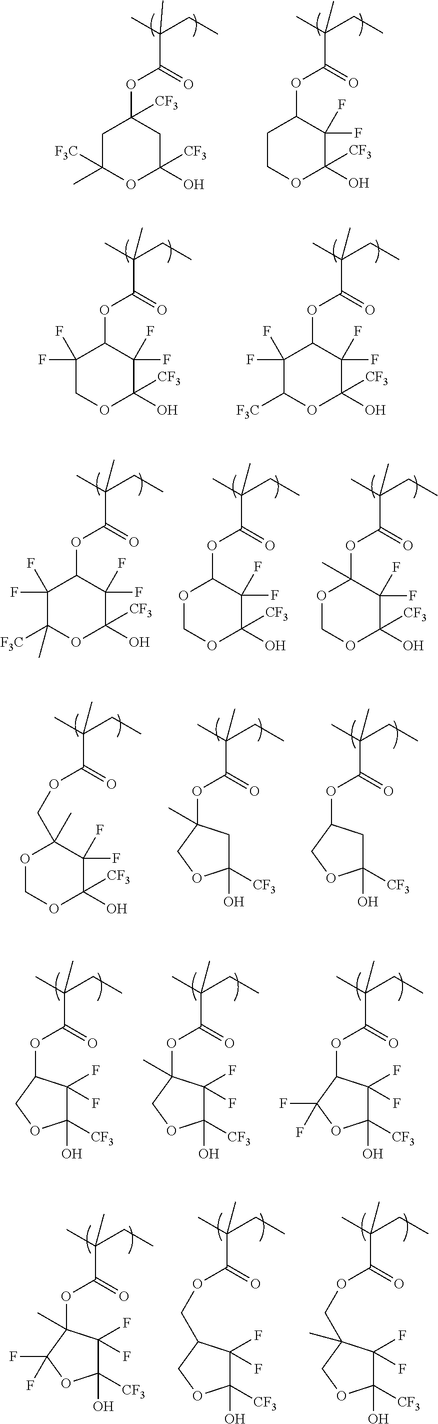

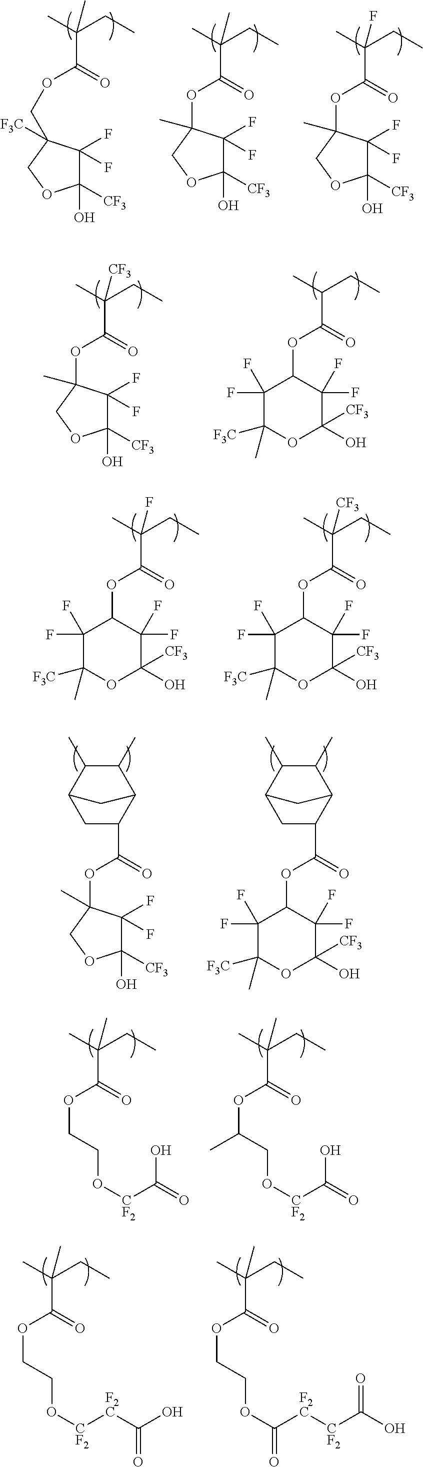

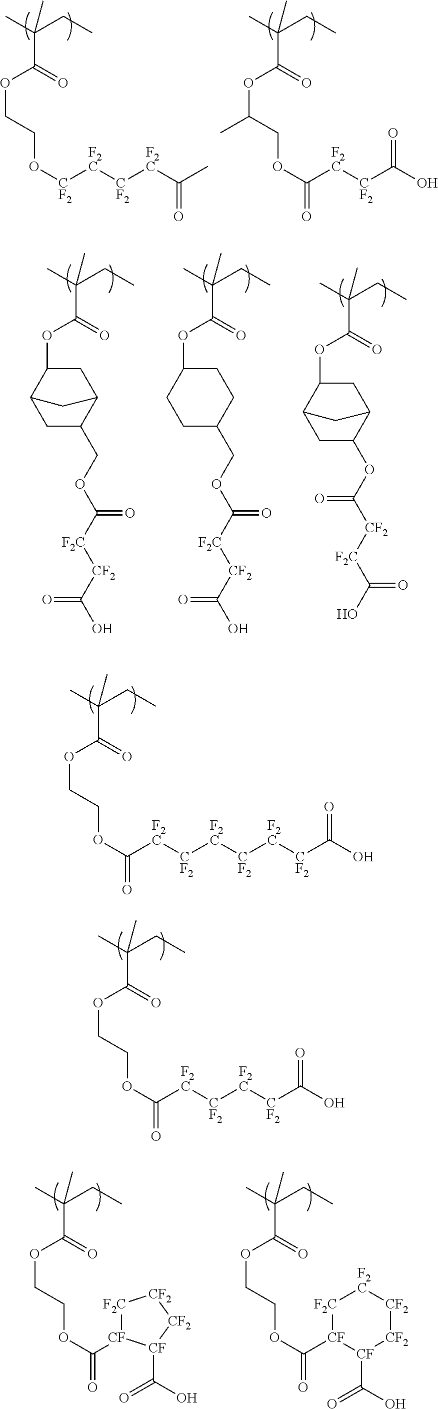

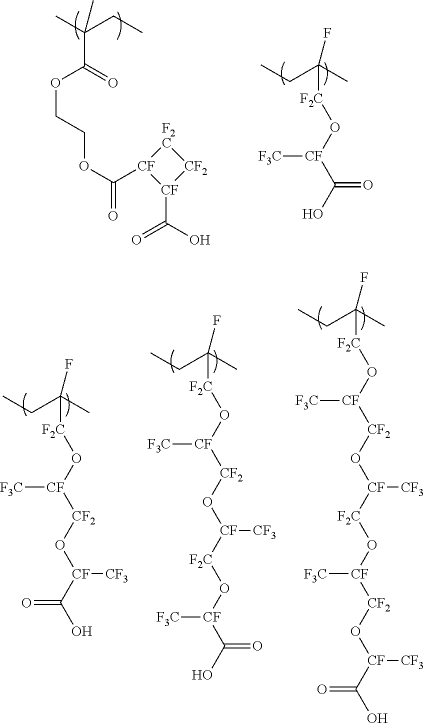

The dissolution rate, in water, of the polymer comprising a repeating unit selected from the water-repellent A1 to A4 in the formula (1) and/or a repeating unit selected from B1 to B3 in the formula (2), and an optional alkaline solution-soluble repeating unit C may be preferably 0.1 Å (angstrom)/s or less. The dissolution rate in a developer of a 2.38% by weight aqueous tetramethylammonium hydroxide solution after formation of a resist protective film may be preferably 300 Å/s or greater. The resist protective film having “alkali solution solubility” can be meant that the resist protective film is preferably soluble in an aqueous alkaline solution as it has contact with the aqueous alkaline solution. The alkali solution-soluble repeating unit C may be incorporated in the polymer when it is necessary for attaining a desirable dissolution rate in an alkaline solution.

Examples of the copolymer constituting the microdomain structure may include (i) a blend of a copolymer comprising a repeating unit selected from A1 to A4 and an optional repeating unit C and a copolymer comprising a repeating unit selected from B1 to B3 and an optional repeating unit C, and (ii) a copolymer comprising a repeating unit selected from A1 to A4, a repeating unit selected from B1 to B3 and an optional repeating unit C.

Blending of polymers having different polarities may be effective for the formation of a microdomain structure. For this purpose, one polymer produced by copolymerization so as to comprise a repeating unit having a fluorine-containing alkyl group and a repeating unit having an alkaline solution-soluble group can be blended with the other polymer produced by copolymerization so as to comprise a repeating unit having an alkyl group and a repeating unit having an alkali soluble group. Further, a block polymer is generally said to be effective as the copolymer constituting a microdomain structure. The block polymer has a merit of controlling the size or distribution of the microdomain structure more precisely than the polymer blend.

The microdomain structure may have preferably a size of 50 nm or less, more preferably 30 nm or less. When its size exceeds 50 nm, scattering of a diffracted light may occur owing to a difference in refractive index between domains so that fluctuations in the resist line after patterning may be caused. In addition, the domain portion tends to form a mixing layer with a resist during baking. For example, a polymer blend of polymers having greatly different polarities such as polystyrene and polysiloxane forms a film containing a huge phase separation. However, when the resist protective film of the present invention has an alkali solution-soluble group introduced therein, the difference in the polarity between the polymers to be blended is not so high so that such a huge microdomain structure is not formed.

The mole fractions of the repeating units A1, A2, A3, A4, B1, B2, B3 and C are represented by a1, a2, a3, a4, b1, b2, b3 and c, respectively. When the resist protective film comprises a blend of polymers, the polymer comprising a repeating unit having a fluorine-containing alkyl group may preferably satisfy the following equations: 0.1≦a1+a2+a3+a4≦0.9, 0≦c≦0.9, and a1+a2+a3+a4+c=1, while the polymer comprising a repeating unit having a fluorine-free alkyl group satisfies the following equations: 0.1≦b1+b2+b3≦0.9, 0≦c≦0.9, and b1+b2+b3+c=1.

When the resist protective film comprises a copolymer comprising a repeating unit having a fluorine-containing alkyl group and a repeating unit having a fluorine-free alkyl group, the copolymer may preferably satisfy the following equations: 0.1≦a1+a2+a3+a4≦0.9, 0.1≦b1+b2+b3≦0.9, 0≦c≦0.9, a1+a2+a3+a4+b1+b2+b3+c=1.

The equation: a1+a2+a3+a4+b1+b2+b3+c=1 means that in a polymer comprising repeating units A1, A2, A3, A4, B1, B2, B3 and C, the sum of molar fractions a1, a2, a3, a4, b1, b2, b3, and c is 100 mole % on basis of the sum of molar fractions of all the repeating units.

According to the present invention, the polymer may preferably have a weight average molecular weight of from 1000 to 500000, preferably from 2000 to 30000 as determined by GPC (gel permeation chromatography) using a polystyrene standard. When the weight average molecular weight is too small, the polymer may cause mixing with the resist material or become soluble in water. When the weight average molecular weight is too large, there may be a problem in film formability after spin coating, or alkali solubility may be deteriorated.

Each of these polymers may be prepared by radical polymerization, anionic polymerization, cationic polymerization or the like. When it is prepared by block polymerization, living polymerization such as living anionic polymerization may be effective.

A polymer may be produced by adding a polymerization initiator to monomers having an unsaturated bond for obtaining repeating units A1 to A4, B1 to B3 and C in an organic solvent and carrying out thermal polymerization.

Examples of the organic solvent to be used during the polymerization may include toluene, benzene, tetrahydrofuran, diethyl ether, dioxane, methanol, ethanol and isopropanol.

Examples of the polymerization initiator for radical polymerization may include 2,2′-azobisisobutyronitrile (AIBN), 2,2′-azobis(2,4-dimethylvaleronitrile), dimethyl 2,2-azobis(2-methylpropionate), benzoyl peroxide and lauroyl peroxide. Examples of the initiator for anionic polymerization may include alkyl lithium, wherein sec-butyl lithium and/or n-butyl lithium may be preferably employed as an initiator for living anionic polymerization. Examples of the initiator for cationic polymerization may include acid such as sulfuric acid, phosphoric acid, hydrochloric acid, nitric acid, hypochlorous acid, trichloroacetic acid, trifluoroacetic acid, methanesulfonic acid, trifluoromethanesulfonic acid, camphor sulfonic acid, and tosylic acid; Friedel-Crafts catalyst such as BF₃, AlCl₃, TiCl₄ and SnCl₄; and substances which may easily form cation such as I₂ and (C₆H₅)₃CCl.

The polymerization can be effected by heating at from 50 to 80° C. The reaction time may be from about 2 to 100 hours, preferably from about 5 to 20 hours.

The resist protective film material of the present invention may be preferably employed after the polymer is dissolved in a solvent. In this case, the solvent may be added so as to give the polymer concentration of preferably from 0.1 to 20% by weight, more preferably from 0.5 to 10% by weight from the viewpoints of film formability by the spin coating method.

Although no particular limitation is imposed on the solvent used herein, the solvent which dissolves the resist layer is not preferred. It is not preferable to use the conventional resist solvents including ketones such as cyclohexanone and methyl-2-n-amylketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; and esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate and propylene glycol mono-tert-butyl ether acetate.

Examples of the solvent which does not dissolve the resist layer therein may include higher alcohols having 4 or greater carbon atoms, and non-polar solvents such as toluene, xylene, anisole, hexane, cyclohexane and ether. Of these, higher alcohols having 4 or greater carbon atoms may be especially preferred. Specific examples may include 1-butyl alcohol, 2-butyl alcohol, isobutyl alcohol, tert-butyl alcohol, 1-pentanol, 2-pentanol, 3-pentanol, tert-amyl alcohol, neopentyl alcohol, 2-methyl-1-butanol, 3-methyl-1-butanol, 3-methyl-3-pentanol, cyclopentanol, 1-hexanol, 2-hexanol, 3-hexanol, 2,3-dimethyl-2-butanol, 3,3-dimethyl-1-butanol, 3,3-dimethyl-2-butanol, 2-diethyl-1-butanol, 2-methyl-1-pentanol, 2-methyl-2-pentanol, 2-methyl-3-pentanol, 3-methyl-1-pentanol, 3-methyl-2-pentanol, 3-methyl-3-pentanol, 4-methyl-1-pentanol, 4-methyl-2-pentanol, 4-methyl-3-pentanol, cyclohexanol, diisopropyl ether, diisobutyl ether, di-n-butyl ether, methylcyclopentyl ether and methylcyclohexyl ether.

Fluorine solvents may be also preferably employed because they do not dissolve the resist layer therein. Examples of such fluorine-substituted solvents may include 2-fluoroanisole, 3-fluoroanisole, 4-fluoroanisole, 2,3-difluoroanisole, 2,4-difluoroanisole, 2,5-difluoroanisole, 5,8-difluoro-1,4-benzodioxane, 2,3-difluorobenzyl alcohol, 1,3-difluoro-2-propanol, 2′,4′-difluoropropiophenone, 2,4-difluorotoluene, trifluoroacetaldehyde ethyl hemiacetal, trifluoroacetamide, trifluoroethanol, 2,2,2-trifluoroethyl butyrate, ethyl heptafluorobutyrate, ethyl heptafluorobutylacetate, ethyl hexafluoroglutarylmethyl, ethyl 3-hydroxy-4,4,4-trifluorobutyrate, ethyl 2-methyl-4,4,4-trifluoroacetoacetate, ethyl pentafluorobenzoate, ethyl pentafluoropropionate, ethyl pentafluoropropynylacetate, ethyl perfluorooctanoate, ethyl 4,4,4-trifluoroacetoacetate, ethyl 4,4,4-trifluorobutyrate, ethyl 4,4,4-trifluorocrotonate, ethyl trifluorosulfonate, ethyl 3-(trifluoromethyl)butyrate, ethyl trifluoropyruvate, S-ethyl trifluoroacetate, fluorocyclohexane, 2,2,3,3,4,4,4-heptafluoro-1-butanol, 1,1,1,2,2,3,3-heptafluoro-7,7-dimethyl-4,6-octanedione, 1,1,1,3,5,5,5-heptafluoropentane-2,4-dione, 3,3,4,4,5,5,5-heptafluoro-2-pentanol, 3,3,4,4,5,5,5-heptafluoro-2-pentanone, isopropyl 4,4,4-trifluoroacetoacetate, methyl perfluorodenanoate, methyl perfluoro(2-methyl-3-oxahexanoate), methyl perfluorononanoate, methyl perfluorooctanoate, methyl 2,3,3,3-tetrafluoropropionate, methyl trifluoroacetoacetate, 1,1,1,2,2,6,6,6-octafluoro-2,4-hexanedione, 2,2,3,3,4,4,5,5-octafluoro-1-pentanol, 1H,1H,2H,2H-perfluoro-1-decanol, perfluoro(2,5-dimethyl-3,6-dioxane anionic) acid methyl ester, 2H-perfluoro-5-methyl-3,6-dioxanonane, 1H,1H,2H,3H,3H-perfluorononane-1,2-diol, 1H,1H,9H-perfluoro-1-nonanol, 1H,1H-perfluorooctanol, 1H,1H,2H,2H-perfluorooctanol, 2H-perfluoro-5,8,11,14-tetramethyl-3,6,9,12,15-pentaoxaoctadecane, perfluorotributylamine, perfluorotrihexylamine, methyl perfluoro-2,5,8-trimethyl-3,6,9-trioxadodecanoate, perfluorotripentylamine, perfluorotripropylamine, 1H,1H,2H,3H,3H-perfluoroundecane-1,2-diol, trifluorobutanol, 1,1,1-trifluoro-5-methyl-2,4-hexanedione, 1,1,1-trifluoro-2-propanol, 3,3,3-trifluoro-1-propanol, 1,1,1-trifluoro-2-propyl acetate, perfluorobutyltetrahydrofuran, perfluorodecalin, perfluoro(1,2-dimethylcyclohexane), perfluoro(1,3-dimethylcyclohexane), propylene glycol trifluoromethyl ether acetate, propylene glycol methyl ether trifluoromethyl acetate, butyl trifluoromethylacetate, methyl 3-trifluoromethoxypropionate, perfluorocyclohexanone, propylene glycol trifluoromethyl ether, butyl trifluoroacetate, 1,1,1-trifluoro-5,5-dimethyl-2,4-hexanedione, 1,1,1,3,3,3-hexafluoro-2-propanol, 1,1,1,3,3,3-hexafluoro-2-methyl-2-propanol, 2,2,3,4,4,4-hexafluoro-1-butanol, 2-trifluoromethyl-2-propanol, 2,2,3,3-tetrafluoro-1-propanol, 3,3,3-trifluoro-1-propanol, and 4,4,4-trifluoro-1-butanol. These solvents may be used either singly or in combination of two or more. The solvents are not limited to these examples.

The method for forming a pattern using a non-water-soluble and alkali solution-soluble resist protective film (overlay film) material according to the present invention will be explained.

First, a non-water-soluble and alkali solution-soluble resist protective film (overlay film) material may be formed on or above a photoresist layer by spin coating or the like. The film thus formed may have preferably a thickness within a range of from 10 to 500 nm.

As an exposure method, dry exposure having air or a gas such as nitrogen filled between the resist protective film and a projector lens may be employed. Alternately, immersion exposure having the exposure in a liquid, preferably having a liquid filled between the resist protective film and a projector lens may be employed. In immersion exposure, water may be preferably employed. An exposure wavelength within a range of from 180 to 250 nm may be preferred. In order to prevent intrusion of water into the back side of a wafer or loss of water from a substrate, whether or not a wafer edge or the back side of the wafer has been cleaned and how it has been cleaned may be important. For example, the solvent may be evaporated by baking at a range of 40 to 130° C. for 10 to 300 seconds after spin coating of the resist protective film. When the dry exposure is employed, edge cleaning may be carried out at the time of spin coating. On the other hand, when the immersion exposure is employed, the edge cleaning may not be preferable because contact of a substrate surface having high hydrophilicity with water may leave undesirable water on the substrate surface at the edge of the wafer. Accordingly, the edge cleaning may not be carried out at the time of spin coating of the resist protective film.

After formation of the resist protective film, exposure may be carried out in water by KrF or ArF immersion lithography. The exposure wavelength may be preferably from 180 to 250 nm.

The exposure may be followed by post exposure bake (PEB) and development for 10 to 300 seconds with an alkali developer. A 2.38% by weight aqueous solution of tetramethylammonium hydroxide may be typically used as the alkali developer. The removal of the resist protective film of the present invention and development of the resist film may be preferably carried out simultaneously in order to simplify the process. Water sometimes remains on the resist protective film before the PEB. When the PEB is carried out in the presence of the remaining water, the water passes through the protective film, causes azeotropic dehydration with an acid in the resist so that a pattern cannot be formed. In order to remove the water on the protective film completely before the PEB, it is necessary to dry off or collect the water on the protective film before the PEB by spin drying, purging by dry air or nitrogen on the surface of the protective film, or optimization of the shape of a water collecting nozzle or water collection process on the stage after exposure. The resist protective film of the present invention having high water repellency and excellent water-sliding property can have a feature that water can be collected easily from the film.

No particular limitation is imposed on the type of a resist material. It may be a positive or negative resist material. It may be a hydrocarbon monolayer resist material or a silicon-containing bilayer resist material. A resist material in KrF exposure may preferably include, as a base resin, a polymer obtained by substituting the hydrogen atom of the hydroxy or carboxyl group of polyhydroxystyrene or a polyhydroxystyrene-(meth)acrylate copolymer with an acid labile group.

Resist materials for ArF exposure are required to have, as a base resin, an aromatic-free structure. Specific preferred examples may include polyacrylic acid and derivatives thereof, ternary or quaternary copolymers selected from norbornene derivative-maleic anhydride alternating copolymers and polyacrylic acid or derivatives thereof, ternary or quaternary copolymers selected from tetracyclododecene derivative-maleic anhydride alternating copolymers and thereof and polyacrylic acid or derivatives thereof, ternary or quaternary copolymers selected from norbornene derivative-maleimide alternating copolymers and polyacrylic acid or derivatives thereof, ternary or quaternary copolymers selected from tetracyclododecene derivative-maleimide alternating copolymers and polyacrylic acid or derivatives thereof, polymers of at least two of the above-described ones, and one or more selected from polynorbornene and metathesis ring-opening polymers.

### EXAMPLES

The present invention will hereinafter be described in detail by Synthesis Examples, Examples and Comparative Examples. The present invention is not construed to be limited to or by Examples. In Examples, the abbreviation GPC means gel permeation chromatography. The weight average molecular weight (Mw) and number average molecular weight (Mn) were determined using a polystyrene standard.

The structural formulas of Monomers 1 to 13 used in Synthesis Examples are shown below.

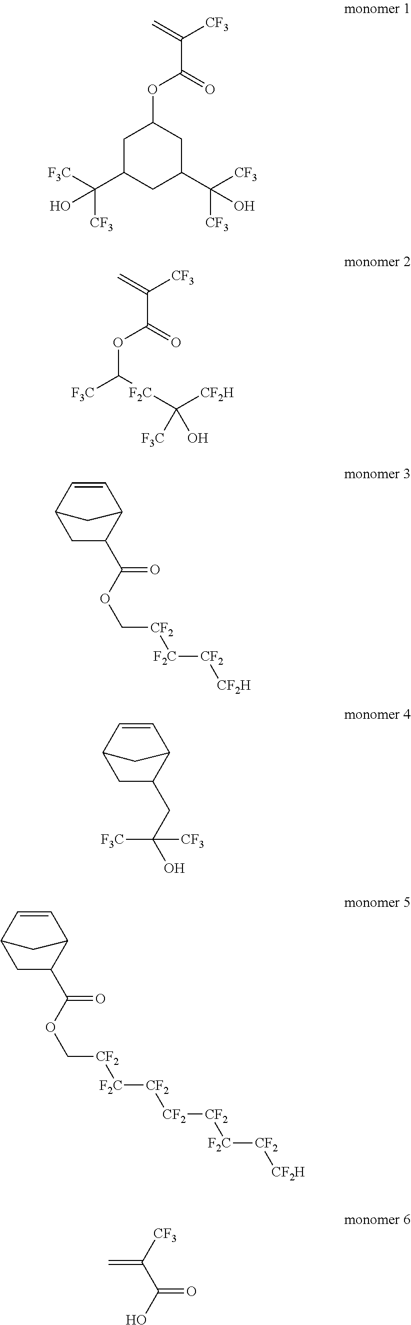

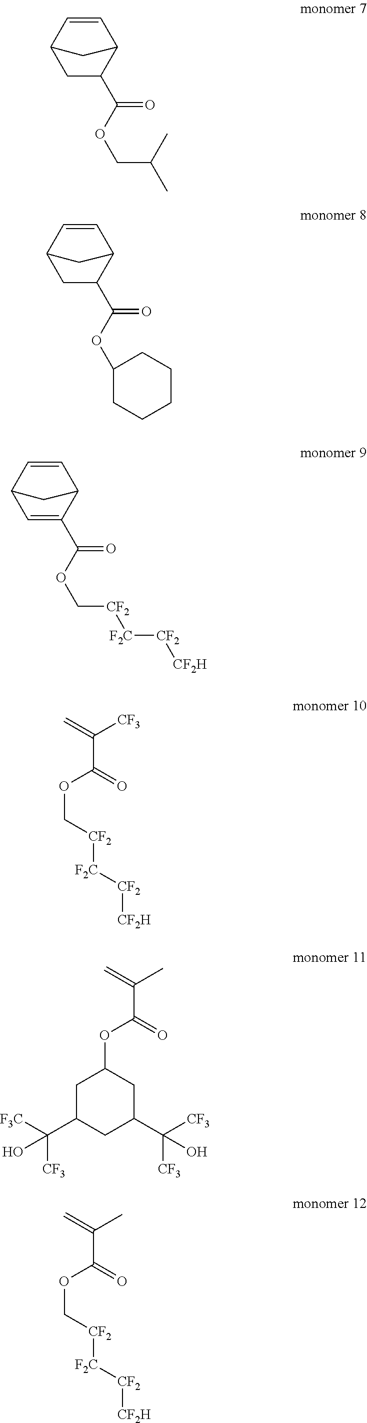

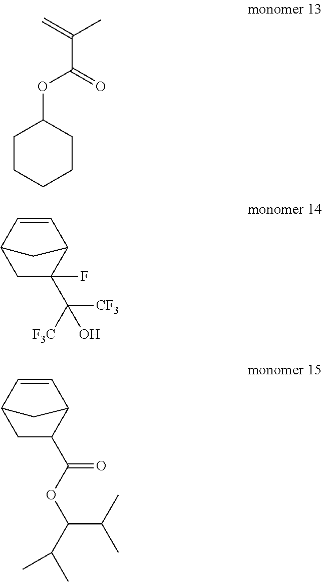

### Synthesis Example 1

A 200-ml flask was charged with 38.7 g of Monomer 1, 6.7 g of Monomer 2 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 1.

### Synthesis Example 2

A 200-ml flask was charged with 38.7 g of Monomer 1, 12.3 g of Monomer 3 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 2.

### Synthesis Example 3

A 200-ml flask was charged with 30.3 g of Monomer 2, 7.7 g of Monomer 8 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization by which the resin was isolated. The composition and molecular weight of the resulting resin were confirmed by ¹H-NMR and GPC, respectively. The resin was designated as Example Polymer 3.

### Synthesis Example 4

A 200-ml flask was charged with 30.3 g of Monomer 2, 12.3 g of Monomer 3 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 4.

### Synthesis Example 5

A 200-ml flask was charged with 30.3 g of Monomer 2, 5.5 g of Monomer 4, 11 g of Monomer 5 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resin were confirmed by ¹H-NMR and GPC, respectively. The resin was designated as Example Polymer 5.

### Synthesis Example 6

A 200-ml flask was charged with 26.0 g of Monomer 2, 1.4 g of Monomer 6, 22 g of Monomer 5 and 40 g of methanol as a solvent. This reaction vessel was cooled to −70° C. in a nitrogen atmosphere, followed by three time repetitions of vacuum deaeration and nitrogen flow, which procedure was repeated three times. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 6.

### Synthesis Example 7

A 200-ml flask was charged with 22.1 g of Monomer 1, 10.6 g of Monomer 10, 11 g of Monomer 4 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resin were confirmed by ¹H-NMR and GPC, respectively. The resin was designated as Example Polymer 7.

### Synthesis Example 8

A 200-ml flask was charged with 17.3 g of Monomer 2, 10.6 g of Monomer 10, 11 g of Monomer 4 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resin were confirmed by ¹H-NMR and GPC, respectively. The resin was designated as Example Polymer 8.

### Synthesis Example 9

A 200-ml flask was charged with 38.7 g of Monomer 1, 14 g of Monomer 9 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 9.

### Synthesis Example 10

A 200-ml flask was charged with 30.3 g of Monomer 2, 14 g of Monomer 9 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 10.

### Synthesis Example 11

A 200-ml flask was charged with 35.0 g of Monomer 11, 4.5 g of Monomer 12, 2.5 g of Monomer 13 and 60 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 11.

### Synthesis Example 12

A 200-ml flask was charged with 35.0 g of Monomer 11, 9.0 g of Monomer 12 and 60 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 12.

### Synthesis Example 13

A 200-ml flask was charged with 35.0 g of Monomer 11, 5.0 g of Monomer 13 and 60 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 13.

### Synthesis Example 14

A 200-ml flask was charged with 15.0 g of Monomer 11, 12.0 g of Monomer 12, 5.0 g of Monomer 13 and 60 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 14.

### Synthesis Example 15

A 200-ml autoclave was charged with 10.9 g of Monomer 4, 1.9 g of Monomer 7 and 40 g of methanol as a solvent. This reaction vessel was cooled to −70° C. in a nitrogen atmosphere, followed by three time repetitions of vacuum deaeration and nitrogen flow. After heating to room temperature, 6.0 g of a tetrafluoroethylene gas and, as a polymerization initiator, 3 g of 2,2′-azobis(2,4-dimethylvaleronitrile) was added. After heating to 45° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 15.

### Synthesis Example 16

A 200-ml autoclave was charged with 9.7 g of Monomer 14, 2.9 g of Monomer 7 and 40 g of methanol as a solvent. This reaction vessel was cooled to −70° C. in a nitrogen atmosphere, followed by three time repetitions of vacuum deaeration and nitrogen flow. After heating to room temperature, 6.0 g of a tetrafluoroethylene gas and, as a polymerization initiator, 3 g of 2,2′-azobis(2,4-dimethylvaleronitrile) was added. After heating to 45° C., the reaction was effected for 25 hours. The reaction solution was poured into hexane for crystallization by which the resin was isolated. The composition and molecular weight of the resulting resin were confirmed by ¹H-NMR and GPC, respectively. The resin was designated as Example Polymer 16.

### Synthesis Example 17

A 200-ml flask was charged with 22.1 g of Monomer 1, 10.6 g of Monomer 10, 11 g of Monomer 14 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 17.

### Synthesis Example 18

A 200-ml flask was charged with 17.3 g of Monomer 2, 10.6 g of Monomer 10, 11 g of Monomer 14 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 18.

### Synthesis Example 19

A 200-ml flask was charged with 38.7 g of Monomer 1, 9.4 g of Monomer 15 and 40 g of methanol as a solvent. This reaction vessel was cooled to −70° C. in a nitrogen atmosphere, followed by three time repetitions of vacuum deaeration and nitrogen flow. After heating to room temperature, 3 g of 2,2′-azobis(2,4-dimethylvaleronitrile) was added as a polymerization initiator. After heating to 65° C., the reaction was effected for 25 hours. The reaction solution was poured into hexane for crystallization, by which the resin was isolated. The composition and molecular weight of the resulting resin were confirmed by ¹H-NMR and GPC, respectively. The resin was designated as Example Polymer 19.

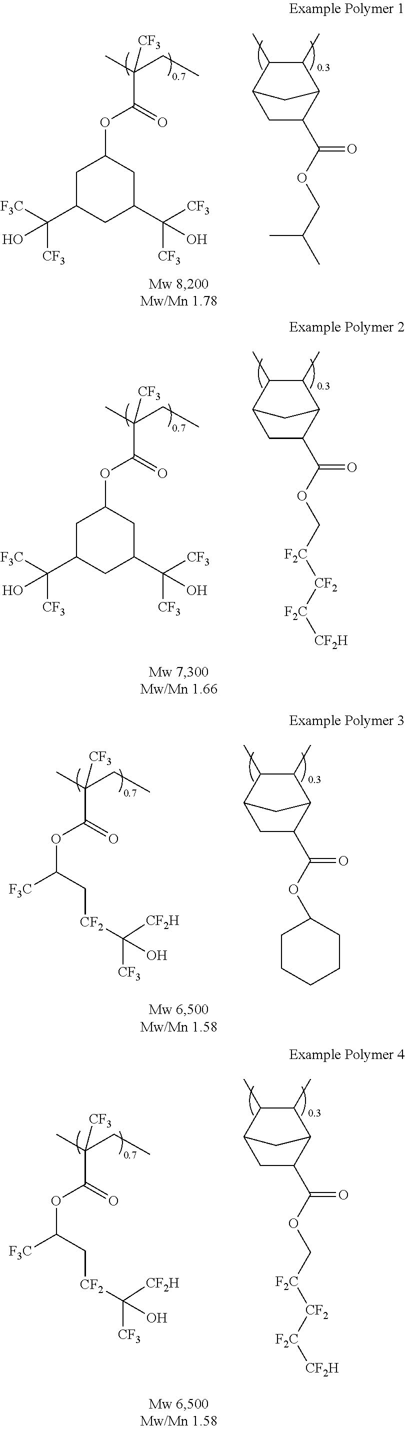

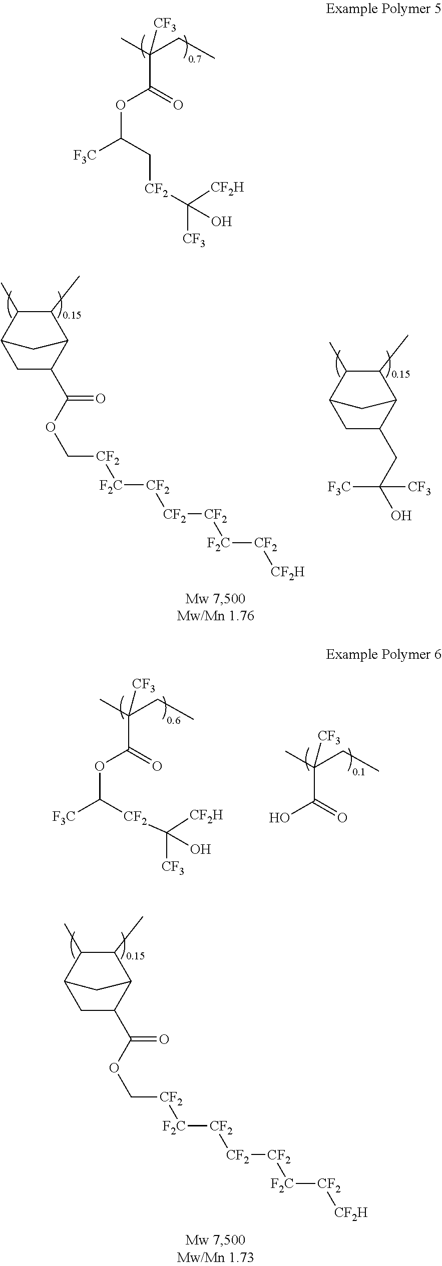

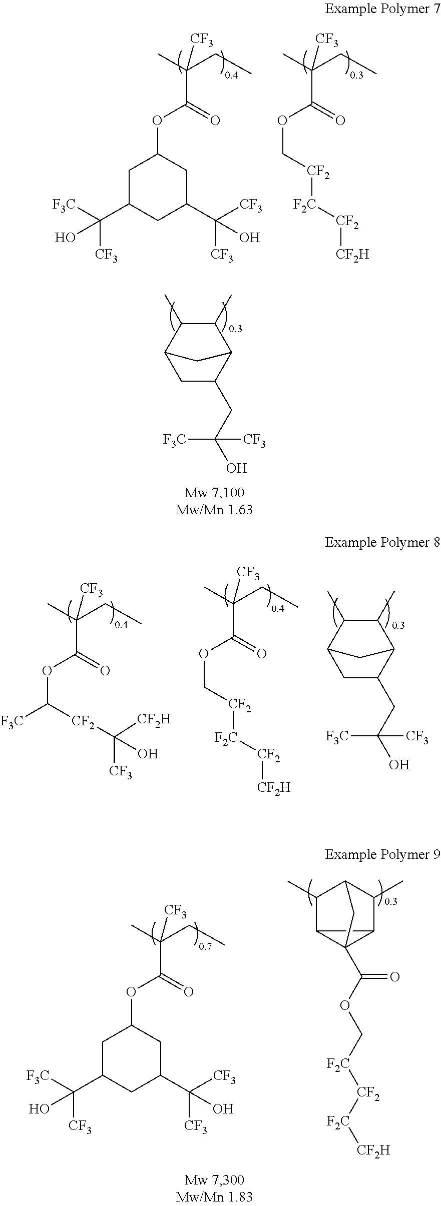

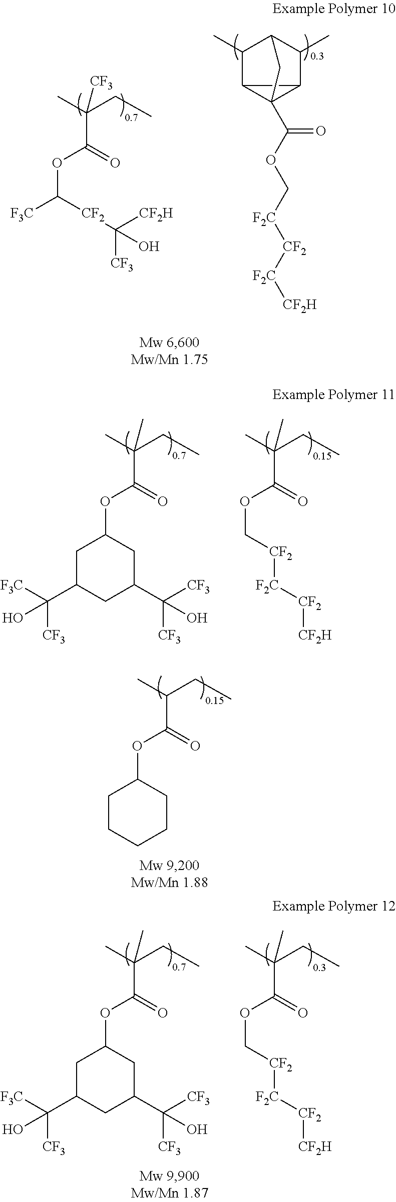

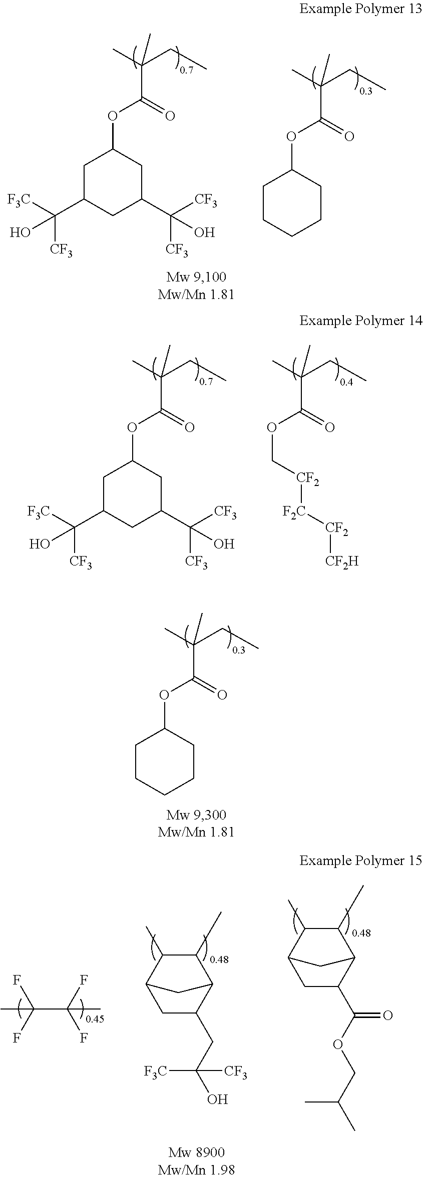

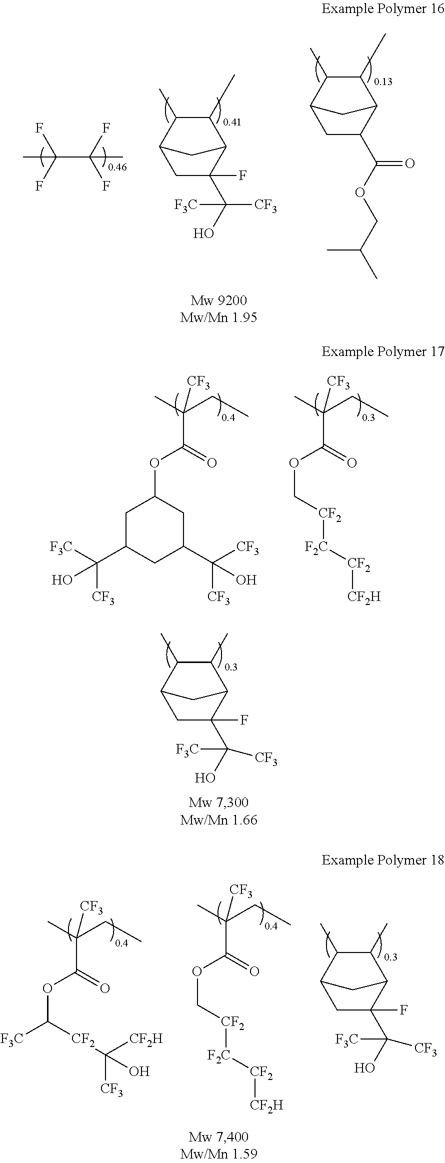

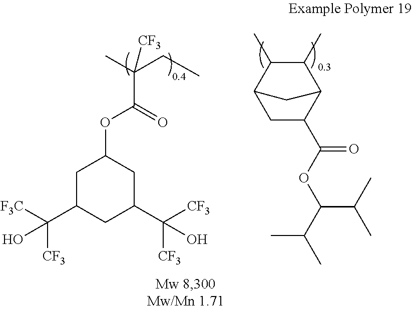

A resist protective film solution was prepared by dissolving 0.5 g of each of Example Polymers 1 to 19 or polymer blends thereof in 25 g of isobutyl alcohol and filtering the resulting solution through a propylene filter having a size of 0.2 μm.

The resulting resist protective film solution was applied onto a silicon waver treated with hexamethyldisilazane (HMDS), followed by baking at 100° C. for 60 seconds, whereby a resist protective film of 50 nm thick was prepared.

The wafer having the resist protective film formed thereon by the above method was rinsed with pure water for 5 minutes and a change of the film thickness was observed. The results are shown in Table 1.

TABLE 1

| | Change of Film Thickness |
|---|---|
| | Before and After the Rinse |
| Polymer for Protective Film | (nm) |
| Example Polymer 1 | 0 |
| Example Polymer 2 | 0 |
| Example Polymer 3 | 0 |
| Example Polymer 4 | 0 |
| Example Polymer 5 | 0 |
| Example Polymer 6 | 0 |
| Example Polymer 7 | 0 |
| Example Polymer 8 | 0 |
| Example Polymer 9 | 0 |
| Example Polymer 10 | 0 |
| Example Polymer 11 | 0 |
| Example Polymer 12 | 0 |
| Example Polymer 13 | 0 |
| Example Polymer 14 | 0 |
| Example Polymer 15 | 0 |
| Example Polymer 16 | 0 |
| Example Polymer 17 | 0 |
| Example Polymer 18 | 0 |
| Example Polymer 19 | 0 |

In addition, the wafer having the resist protective film formed thereon by the above method was developed using a 2.38% by weight aqueous solution of tetramethylammonium hydroxide (TMAH) and a change of the film thickness was observed. The results are shown in Table 2.

TABLE 2

| | Film Thickness |
|---|---|
| | After Development |
| Polymer for Protective Film | (nm) |
| Example Polymer 1 | 0 |
| Example Polymer 2 | 0 |
| Example Polymer 3 | 0 |
| Example Polymer 4 | 0 |
| Example Polymer 5 | 0 |
| Example Polymer 6 | 0 |
| Example Polymer 7 | 0 |
| Example Polymer 8 | 0 |
| Example Polymer 9 | 0 |
| Example Polymer 10 | 0 |
| Example Polymer 11 | 0 |
| Example Polymer 12 | 0 |
| Example Polymer 13 | 0 |
| Example Polymer 14 | 50 |
| Example Polymer 15 | 0 |
| Example Polymer 16 | 0 |
| Example Polymer 17 | 0 |
| Example Polymer 18 | 0 |
| Example Polymer 19 | 0 |

Example Polymer 14 is insoluble in an alkali solution and a resist protective film produced by using Example Polymer 14 is a film removable by an organic solvent. A change of the film thickness was observed after di-n-butyl ether was paddled on the resulting film and then spin-dried. The results are shown in Table 3.

TABLE 3

| | Film Thickness |
|---|---|
| | After Solvent Paddle |
| Polymer for Protective Film | (nm) |
| Example Polymer 14 | 0 |

On the wafer which had the resist protective film formed thereon and was kept horizontal, 50 μL of pure water was fallen to form a water droplet. The wafer was then gradually inclined and an angle (sliding angle) of the wafer at which the water droplet started sliding was determined. The results are shown in Tables 4 and 5.

TABLE 4

| Resist | | Sliding Angle |
|---|---|---|
| Protective Film | Polymer for Protective Film | (degree) |
| TC-1 | Example Polymer 1 | 24 |
| TC-2 | Example Polymer 2 | 28 |
| TC-3 | Example Polymer 3 | 23 |
| TC-4 | Example Polymer 4 | 24 |
| TC-5 | Example Polymer 5 | 28 |
| TC-6 | Example Polymer 6 | 30 |
| TC-7 | Example Polymer 7 | 25 |
| TC-8 | Example Polymer 8 | 26 |
| TC-9 | Example Polymer 9 | 25 |
| TC-10 | Example Polymer 10 | 26 |
| TC-11 | Example Polymer 11 | 18 |
| TC-12 | Example Polymer 12 | 21 |
| TC-13 | Example Polymer 13 | 23 |
| TC-14 | Example Polymer 14 | 17 |
| TC-15 | Example Polymers 1 and 2 | 18 |
| | weight ratio 1:1 | |
| TC-16 | Example Polymers 3 and 4 | 18 |
| | weight ratio 1:1 | |
| TC-17 | Example Polymers 1 and 5 | 22 |
| | weight ratio 1:1 | |
| TC-18 | Example Polymers 1 and 6 | 24 |
| | weight ratio 1:1 | |
| TC-19 | Example Polymers 1 and 7 | 18 |
| | weight ratio 1:1 | |
| TC-20 | Example Polymers 1 and 8 | 19 |
| | weight ratio 1:1 | |
| TC-21 | Example Polymers 1 and 9 | 20 |
| | weight ratio 1:1 | |
| TC-22 | Example Polymers 1 and 10 | 21 |
| | weight ratio 1:1 | |
| TC-23 | Example Polymers 12 and 13 | 18 |
| | weight ratio 1:1 | |

TABLE 5

| Resist | | Sliding Angle |
|---|---|---|
| Protective Filml | Polymer for Protective Film | (degree) |
| TC-24 | Example Polymer 15 | 15 |
| TC-25 | Example Polymer 16 | 17 |
| TC-26 | Example Polymer 17 | 25 |
| TC-27 | Example Polymer 18 | 24 |
| TC-28 | Example Polymer 19 | 22 |
| TC-29 | Example Polymers 1 and 17 | 16 |
| | weight ratio 1:1 | |
| TC-30 | Example Polymers 1 and 18 | 17 |
| | weight ratio 1:1 | |
| TC-31 | Example Polymers 19 and 2 | 14 |
| | weight ratio 1:1 | |
| TC-32 | Example Polymers 19 and 4 | 15 |
| | weight ratio 1:1 | |
| TC-33 | Example Polymers 19 and 17 | 16 |
| | weight ratio 1:1 | |
| TC-34 | Example Polymers 19 and 18 | 15 |
| | weight ratio 1:1 | |

A small sliding angle means that high flowability of water. At a small sliding angle, scanning speed can be raised in scan exposure. When the polymer of the present invention comprising a repeating unit having a fluorine-containing alkyl group and a repeating unit having a fluorine-free alkyl group is used, a sliding angle tends to become smaller compared with use of a polymer having a repeating unit of a fluorine-containing alkyl group and a polymer having a repeating unit of a fluorine-free alkyl group.

A resist solution was prepared by dissolving 5 g of the below-described resist polymer, 0.25 g of PAG, and 0.5 g of 12 Mp serving as a quencher, in 55 g of propylene glycol monoethyl ether acetate (PGMEA) solution and filtering the resulting solution through a polypropylene filter of 0.2 μm in size. The resist solution thus obtained was applied to a 87-nm thick antireflective film “ARC-29A” (trade name; product of Nissan Chemical Co., Ltd.) formed on an Si substrate, followed by baking at 120° C. for 60 seconds to form a resist film of 150 nm thick. A resist protective film was then applied to the resist film and baked at 120° C. for 60 seconds. In order to simulate immersion exposure, the film after exposure was rinsed with pure water for 5 minutes. The resulting wafer was exposed using an ArF scanner “S307E” (trade name; product of Nikon Corp., NA 0.85, σ 0.93, 4/5 annular illumination, 6% halftone phase shift mask), rinsed for 5 minutes while pouring pure water to the wafer, post-exposure baked (PEB) at 120° C. for 60 seconds, and developed with a 2.38% by weight TMAH developer for 60 seconds.

A wafer having a similar structure but having no protective film formed thereon was also subjected to the above-described exposure, rinsing with pure water, the PEB and the development; and a wafer having no protective film was also subjected to ordinary process including the above-described treatments except rinsing with pure water.

The wafers were each cleaved for comparing the profile of 75-nm line-and-space pattern and sensitivity. The results are shown in Table 6.

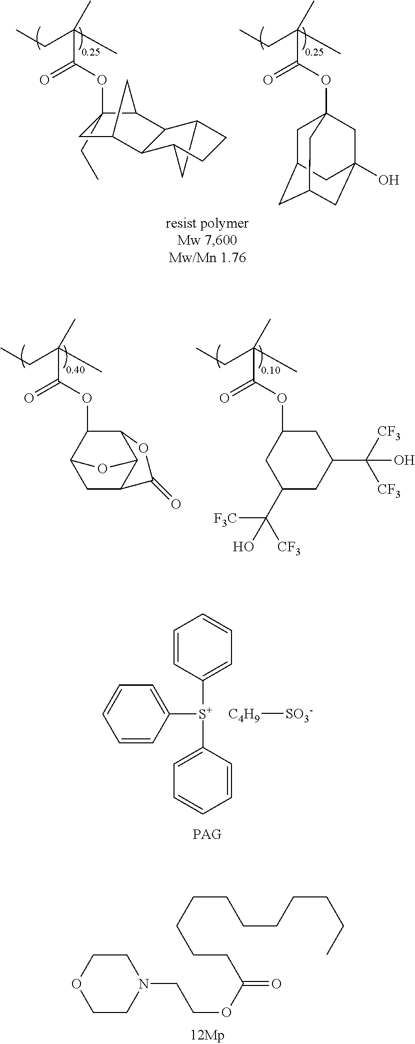

TABLE 6

| Resist Protective Film | 75 nm Pattern Profile |
|---|---|
| conventional process | 35 mJ/cm² rectangular |
| without protective film and | |
| without rinse after exposure | |
| TC-1 | 35 mJ/cm² rectangular |
| TC-2 | 35 mJ/cm² rectangular |
| TC-3 | 35 mJ/cm² rectangular |
| TC-4 | 35 mJ/cm² rectangular |
| TC-5 | 35 mJ/cm² rectangular |
| TC-6 | 35 mJ/cm² rectangular |
| TC-7 | 35 mJ/cm² rectangular |
| TC-8 | 35 mJ/cm² rectangular |
| TC-9 | 35 mJ/cm² rectangular |
| TC-10 | 35 mJ/cm² rectangular |
| TC-11 | 35 mJ/cm² rectangular |
| TC-12 | 35 mJ/cm² rectangular |
| TC-13 | 35 mJ/cm² rectangular |
| TC-15 | 35 mJ/cm² rectangular |
| TC-16 | 35 mJ/cm² rectangular |
| TC-17 | 35 mJ/cm² rectangular |
| TC-18 | 35 mJ/cm² rectangular |
| TC-19 | 35 mJ/cm² rectangular |
| TC-20 | 35 mJ/cm² rectangular |
| TC-21 | 35 mJ/cm² rectangular |
| TC-22 | 35 mJ/cm² rectangular |
| TC-23 | 35 mJ/cm² rectangular |
| TC-24 | 35 mJ/cm² rectangular |
| TC-25 | 35 mJ/cm² rectangular |
| TC-26 | 35 mJ/cm² rectangular |
| TC-27 | 35 mJ/cm² rectangular |
| TC-28 | 35 mJ/cm² rectangular |
| TC-29 | 35 mJ/cm² rectangular |
| TC-30 | 35 mJ/cm² rectangular |
| TC-31 | 35 mJ/cm² rectangular |
| TC-32 | 35 mJ/cm² rectangular |
| TC-33 | 35 mJ/cm² rectangular |
| TC-34 | 35 mJ/cm² rectangular |
| without protective film | 35 mJ/cm² T-top |

A resist solution was applied to an 87-nm thick antireflective film “ARC-29A” (trade name; product of Nissan Chemical Co., Ltd.) formed on an Si substrate, followed by baking at 120° C. for 60 seconds to form a resist film of 150 nm thick. A resist protective film was then applied onto the resist film and baked at 120° C. for 60 seconds. In order to simulate immersion exposure, the film after exposure was rinsed with pure water for 5 minutes. The resulting wafer was exposed using an ArF scanner “S307E” (trade name; product of Nikon Corp., NA 0.85, σ 0.93, 4/5 annular illumination, 6% halftone phase shift mask), rinsed for 5 minutes while pouring pure water to the wafer, and post-exposure baked (PEB) at 110° C. for 60 seconds. After the resist protective film was removed by paddling di-n-butyl ether thereto and spin drying, development was performed using a 2.38% by weight TMAH developer for 60 seconds.

The wafer was cleaved for comparing the profile of 75-nm line-and-space pattern and sensitivity. The results are shown in Table 7.

TABLE 7

| Resist Protective Film | 75 nm Pattern Profile |
|---|---|
| TC-14 | 35 mJ/cm² rectangular |

When the wafer having no protective film formed thereon was rinsed with pure water after exposure, the pattern had a T-top profile. This occurs because the acid generated was dissolved in water. The pattern profile remained unchanged when the protective film of the present invention was used. When the protective film comprises mainly methacrylate, the resist profile after development was a T-top profile with the head stretched and with the film thickness decreased.

The resist protective film of the present invention suited for immersion lithography is obtained by using combination of a fluorine-containing alkyl group and a fluorine-free alkyl group as a hydrophobic group. It is superior in water-sliding property to a protective film prepared using a fluorine-containing alkyl group alone or a fluorine-free alkyl group alone, while it does not mix with the resist film in a same manner as the protective film prepared using a fluorine-containing alkyl group alone or a fluorine-free alkyl group alone. Accordingly, the resist protective film of the present invention can provides the desirable immersion lithography. The addition of an alkaline-soluble repeating unit can provide the protective film having alkaline solution-solubility improved so that development of the resist film and removal of the protective film can be carried out simultaneously during alkali development.

1. A method for forming a pattern, comprising forming a protective film using a protective film material, comprising:
a blend of a first polymer comprising a repeating unit having a fluorine-containing alkyl or alkylene group which contains at least one fluorine atom and a second polymer comprising a repeating unit having a fluorine-free alkyl group, or
a polymer comprising the repeating unit having a fluorine-containing alkyl or alkylene group and the repeating unit having a fluorine-free alkyl group,
on or above a photoresist layer formed on or above a wafer, a subsequent exposure step and a development step.

2. The method for forming a pattern according to claim 1, wherein said exposure step comprises an exposure in a liquid.

3. The method for forming a pattern according to claim 1, wherein said exposure step comprises inserting a liquid between a projection lens and a wafer and using an exposure wavelength within a range of from 180 to 250 nm.

4. The method for forming a pattern according to claim 1, wherein said development step comprises simultaneously developing the photoresist layer and removing the protective film using an alkali developer.

5. The method for forming a pattern according to claim 1, wherein said first polymer further comprises an alkaline solution-soluble repeating unit and said second polymer further comprises an alkali soluble repeating unit.

6. The method for forming a pattern according to claim 1, wherein said polymer comprising the repeating unit having a fluorine-containing alkyl or alkylene group and the repeating unit having a fluorine-free alkyl group further comprises an alkaline solution-soluble repeating unit.

7. The method for forming a pattern according to claim 1, wherein said repeating unit having a fluorine-containing alkyl group is selected from the group consisting of repeating units A1, A2 and A3 in formula (1), said repeating unit having a fluorine-containing alkylene group is selected from A4 in formula (1), and said repeating unit having a fluorine-free alkyl group is selected from the group consisting of repeating units B1, B2 and B3 in formula (2): 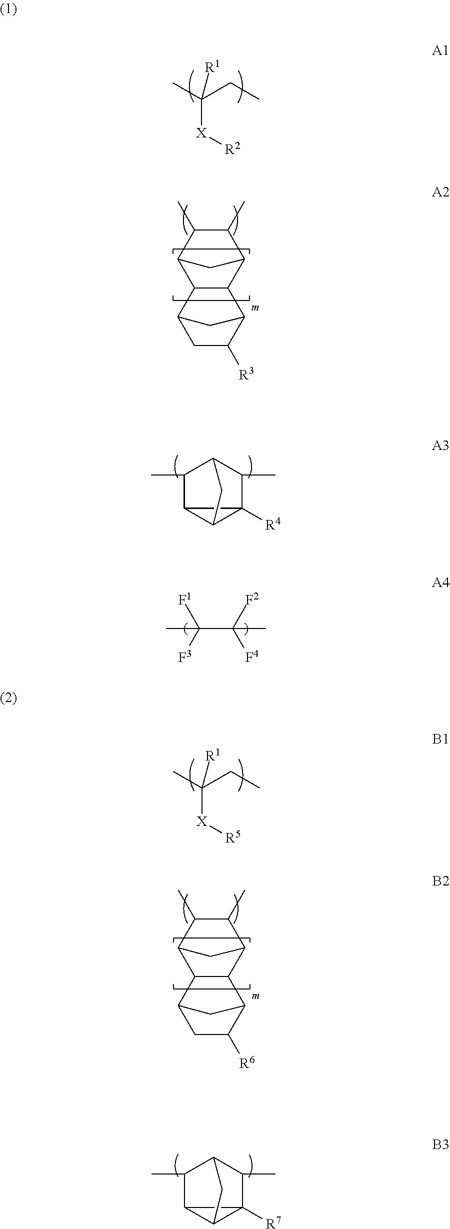
wherein R¹ represents a hydrogen atom, a fluorine atom, a methyl group or a trifluoromethyl group; R², R³ and R⁴ each independently represents a C₁₋₂₀ alkyl group having at least one fluorine atom and may have an ether or ester group; X represents —O— or —C(═O)—O—; m represents 0 or 1; F¹ to F⁴ each independently represents an atom or group selected from the group consisting of a fluorine atom, a hydrogen atom, a methyl group and a trifluoromethyl group, being provided that at least one of F¹ to F⁴ contains at least one fluorine atom; R⁵ and R⁶ each independently represents a fluorine-free C₁₋₂₀ alkyl group and may have an ether or ester group; and R⁷ represents a hydrogen atom or fluorine-free C₁₋₂₀ alkyl group and may contain an ether or ester group.

8. The method for forming a pattern according to claim 1, wherein said fluorine-containing alkyl group is a perfluoroalkyl group or a substituted perfluoroalkyl group having a difluoromethyl group instead of a trifluoromethyl group.

9. The method for forming a pattern according to claim 1, further comprising a solvent capable of dissolving said polymer or polymers.
